(19) United States
(12) Patent Application Publication
(10) Pub. No.: US 2016/0103975 A1
(43) Pub. Date: Apr. 14, 2016

(54) PRE-VERIFICATION OF PRESCRIPTIONS

(71) Applicant: Envision Pharmaceutical Holdings LLC, Twinsburg, OH (US)

(72) Inventors: Andrew Gairani, Naperville, IL (US); James Knowles, Round Hill, VA (US)

(21) Appl. No.: 14/882,138

(22) Filed: Oct. 13, 2015

Related U.S. Application Data
(60) Provisional application No. 62/062,577, filed on Oct. 10, 2014.

(51) Int. Cl. G06F 19/00

(52) U.S. Cl. CPC G06F 19/3456; G06F 19/322

(57) ABSTRACT

A plurality of available effective selections is determined in accordance with a prescription. A differential value for one of the selections is determined based on insurance coverage, values of the available effective selections, and a predetermined maximum value for the differential value. The differential value and the available effective selections and their associated values are transmitted to a user computer device over a network.

### CROSS REFERENCE TO RELATED APPLICATIONS

This application claims benefit under 35 U.S.C. §119(e) of U.S. Provisional Patent Application No. 62/062,577, filed Oct. 10, 2014, the contents of which are incorporated herein by reference in its entirety.

### BACKGROUND

The cost and complexity of distributing and providing prescription medication and information have continued to rise. Manufactures and providers of prescription medications have sought ways to more efficiently distribute and make available the medication and information. The manufactures and providers of prescription medications may also desire to find ways to maintain competitive advantages in the prescription drug market.

### BRIEF DESCRIPTION OF THE DRAWINGS

In the accompanying drawings, which illustrate one or more example embodiments:

FIG. 1 is a diagram illustrating a system for providing medical information in accordance with the present disclosure.

FIG. 2 is a diagram illustrating operations for providing medical information in accordance with the present disclosure.

FIG. 3 is a diagram illustrating operations for providing medical information in accordance with the present disclosure.

FIG. 4 is a diagram illustrating operations for providing medical information in accordance with the present disclosure.

FIG. 5A is a diagram illustrating operations for providing medical information in accordance with the present disclosure.

FIG. 5B is a diagram illustrating operations for providing medical information in accordance with the present disclosure.

FIG. 6 is a diagram illustrating operations for providing medical information in accordance with the present disclosure.

FIG. 7 is a diagram illustrating operations for providing medical information in accordance with the present disclosure.

FIG. 8 is a diagram illustrating operations for providing medical information in accordance with the present disclosure.

FIG. 9 is a diagram illustrating operations for providing medical information in accordance with the present disclosure.

FIG. 10 is a diagram illustrating operations for providing medical information in accordance with the present disclosure.

FIG. 11 illustrates a user interface and operations for providing medical information in accordance with the present disclosure.

FIG. 12 illustrates a user interface and operations for providing medical information in accordance with the present disclosure.

FIG. 13 illustrates a user interface and operations for providing medical information in accordance with the present disclosure.

FIG. 14 illustrates a user interface and operations for providing medical information in accordance with the present disclosure.

FIG. 15 illustrates a user interface and operations for providing medical information in accordance with the present disclosure.

FIG. 16 illustrates a user interface and operations for providing medical information in accordance with the present disclosure.

FIG. 17 illustrates a user interface and operations for providing medical information in accordance with the present disclosure.

FIG. 18 illustrates a user interface and operations for providing medical information in accordance with the present disclosure.

FIG. 19 illustrates a user interface and operations for providing medical information in accordance with the present disclosure.

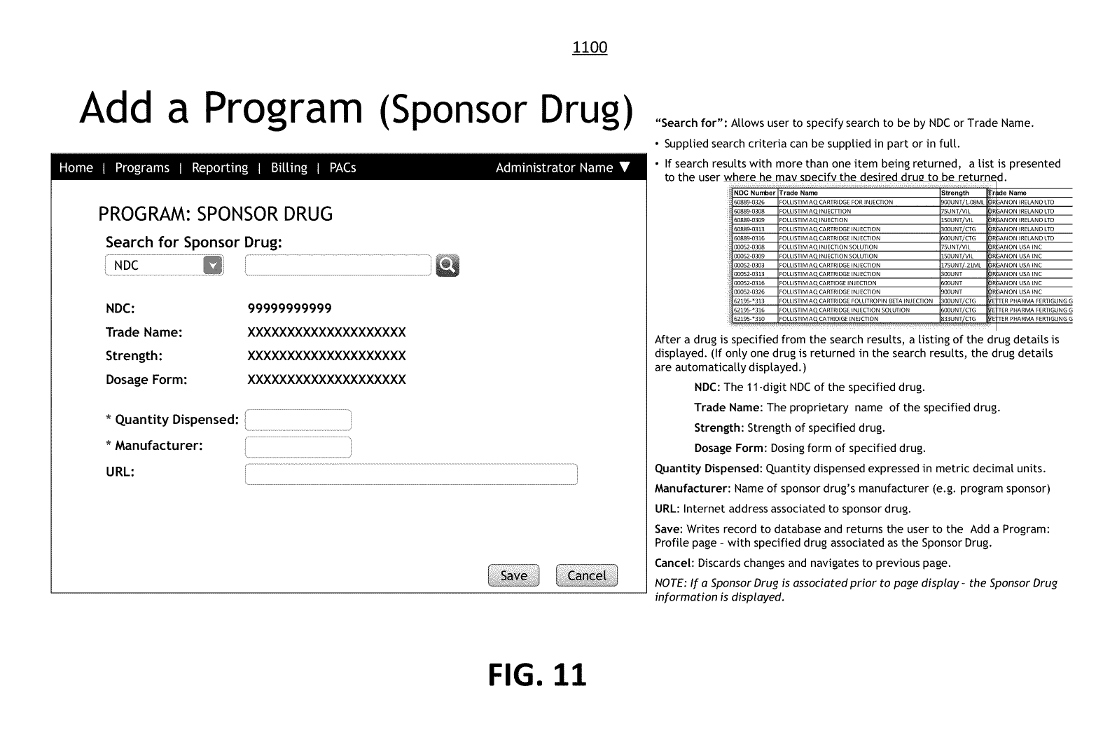

FIG. 11 illustrates a user interface and operations for providing medical information in accordance with the present disclosure.

FIG. 20 illustrates a user interface and operations for providing medical information in accordance with the present disclosure.

FIG. 21 illustrates a user interface and operations for providing medical information in accordance with the present disclosure.

FIG. 22 illustrates a user interface and operations for providing medical information in accordance with the present disclosure.

FIG. 23 illustrates a user interface and operations for providing medical information in accordance with the present disclosure.

FIG. 24 illustrates a user interface and operations for providing medical information in accordance with the present disclosure.

FIG. 25 illustrates a user interface and operations for providing medical information in accordance with the present disclosure.

FIG. 26 illustrates a user interface and operations for providing medical information in accordance with the present disclosure.

FIG. 27 illustrates a user interface and operations for providing medical information in accordance with the present disclosure.

FIG. 28 illustrates a user interface and operations for providing medical information in accordance with the present disclosure.

FIG. 29 illustrates a user interface and operations for providing medical information in accordance with the present disclosure.

FIG. 30 illustrates a user interface and operations for providing medical information in accordance with the present disclosure.

FIG. 31 illustrates a user interface and operations for providing medical information in accordance with the present disclosure.

FIG. 32 illustrates a user interface and operations for providing medical information in accordance with the present disclosure.

FIG. 33 illustrates a user interface and operations for providing medical information in accordance with the present disclosure.

FIG. 34 illustrates a user interface and operations for providing medical information in accordance with the present disclosure.

FIG. 35 illustrates a user interface and operations for providing medical information in accordance with the present disclosure.

FIG. 36 illustrates a user interface and operations for providing medical information in accordance with the present disclosure.

FIG. 37 illustrates a user interface and operations for providing medical information in accordance with the present disclosure.

FIG. 38 illustrates a user interface and operations for providing medical information in accordance with the present disclosure.

FIG. 39 illustrates a user interface and operations for providing medical information in accordance with the present disclosure.

FIG. 40 is a diagram illustrating an example process for providing medical information that may be used in accordance with the present disclosure.

FIG. 41 is a diagram illustrating an example computing system that may be used in accordance with the present disclosure.

### DETAILED DESCRIPTION OF ILLUSTRATIVE EMBODIMENTS

Typically, medical prescriptions are sent electronically to a pharmacy from a physician's office or other medical facility. Alternatively, a patient may carry a written prescription to the pharmacy for fulfillment. The pharmacy may review the information provided in the prescription and access information related to the prescribed medication. The pharmacy may review, for example, cost data for the prescribed medication as well as alternatives if available and allowed. During this process, the patient may have little or no information regarding the available options and the costs for the prescribed medications. The patient may also have little or no access to cost-effective alternative medications, and little or no control as to the selection of costs and the options of the cost-effective alternative medications.

Accordingly, one of the drawbacks of prescription medication fulfillment today is that patients do not have timely and real-time information and thus are generally not fully informed of the pricing and selection of prescription drugs. Furthermore, in many cases a practitioner does not ask or receive input from the patient regarding what brand of medication that the patient prefers. Furthermore, the practitioners themselves are often not be aware of the price difference between medications and their alternatives. Additionally, manufacturers of medications may not have a way to provide patients with pricing and other information regarding their medications, as well as a way to consider and communicate incentives to patients prior to the purchasing decision that is made at the pharmacy.

Accordingly, there exists a need for systems and methods that provide the patient with timely information regarding all of the options that are available for a given medication. Furthermore, it would be useful for the patient to have access to this information prior to arriving at the pharmacy or before a selection decision is to be made. Additionally, it would be useful for the information to be made available to the patient via a variety of electronic and computer-based methods. A system that accesses information pertaining to the practitioner, the patient, the drug manufacturer, and pharmacy, processes the information, and provides selected processed information to the patient may be implemented as described herein to provide the processed information in an efficient and secure manner to the patient.

In some embodiments, a system is described for pre-processing and pre-verification of medical prescriptions. In one embodiment, such a system may be configured to receive a recommended effective form, type, administration, and amount of a composition such as that typically included in a prescription. The system may process the received information and generate a list of available options that fulfill the recommendation. The generated list may be made available electronically prior to a patient arriving at a pharmacy or prior to the patient making a selection decision. The generated list may by generate using information from the manufacturer, the patient's physician, the patient, and the patient's insurance provider. The generated list may further include a recommendation of a selected cost-efficient medicine for the patient. After receiving the information including the generated list and recommendation, the patient may access the information on a computing device such as a tablet or smartphone. Such information may not have been previously available for access to the patient. The presentation of the information on a computing device may allow for the patient to review the information in real-time and make a more informed selection for medication. The system may thus allow a patient to research a patient's prescription benefits prior to the pharmacy receiving the prescription, and may also allow for expediting the patient's treatment planning.

In some embodiments, alternatives for fulfilling the prescription may be provided and may include lower cost alternative compositions of medications that may be available to a patient prior to arriving at a pharmacy. For example, a generated list may be provided that includes one or more medication options provided by a manufacturer. The generated list may also include a plan outlining information for each of the medication options and that are in fulfillment of the effective form, type, administration, and amount of the prescribed medication.

In some embodiments, a prescription may be pre-verified prior to the patient interacting with a pharmacy. Pre-verification may include researching the patient's insurance benefits prior to the pharmacy receiving the prescription. Through pre-verification, patients may be provided with more and timely information related to available options for fulfillment of prescriptions. By providing the information on the user's computing device or making the information accessible by a computing device, processing time by the pharmacy may be reduced. Additionally, confusion related to formulary rejection may be reduced by providing the patient with the information at an earlier time. The patient may also be provided information at an earlier time related to managed care messaging.

The manufacturers of prescription drugs may benefit by such a system by providing patients with the most cost-efficient drugs quickly and efficiently. Furthermore, the manufacturer may be enabled to provide information more quickly and directly to the patient. The manufacturer may also be provided a way to directly communicate with the patients' computing device or provide a means to send information to the patient's computing device. Manufacturers may also be able to determine if an incentive may be provided to the patient to influence the patient's selection decision. In one embodiment, the manufacturer may determine a discount amount or generate a coupon that offsets pricing differentials with alternative compositions. Specific amounts for the discount may be determined based on the specific information associated with the patient and the patient's prescription. In this way the manufacturer may be able to provide timely and customized incentive information that may allow for increased exposure and consideration of the incentive information in view of alternative medications.

The described system and method may also allow patients to provide more direct control over the selection of available medications based on price and other factors. The access and presentation of data may allow patients to better understand coverage and associated costs, provide for improved patient education, and allow for better understood and more comprehensive patient planning. The described system and method may also allow patients to save time by having access to all of the available information prior to going to the pharmacy.

In one embodiment, a system for pre-verifying prescriptions may be implemented by one or more computing systems that comprise processors and memory. The system may be configured to compile information for prescriptions, access medical information for a user, store the medical information, generate a list of prescription options based on the medical information, and present to the user a list of prescription options and associated information.

Terms such as “medications,” “prescription drugs,” “medicine,” and “prescriptions,” are used in the following description for the purpose of describing medicine available at a pharmacy or local drug store. Terms such as “physician” and “practitioner” are used in the following description for the purpose of describing a licensed medical doctor or nurse with the capability of prescribing drugs.

A patient's information may include, but are not limited to: the patient's contact information (i.e., name, address, and telephone number), date of birth, insurance details, and physician information.

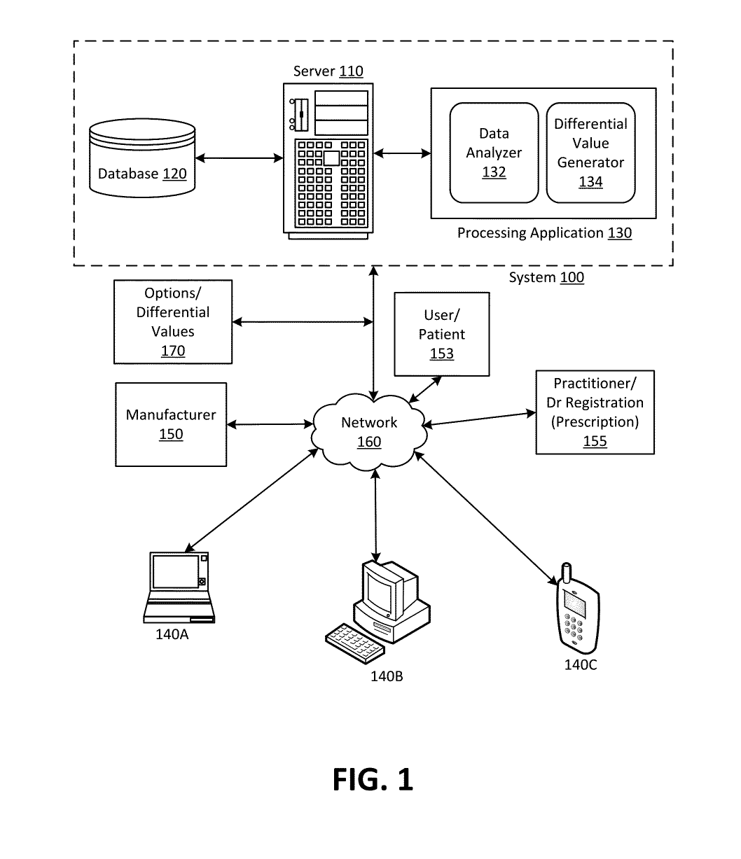

Referring to FIG. 1, illustrated is an example system 100 for providing medical information in accordance with the present disclosure. In FIG. 1, system 100 may include a server 110 that may execute resources and applications for processing and providing medical information. In one embodiment, server 110 may execute a data analyzer 132 configured to receive and analyze prescription information and generate a list of available options that fulfill the prescription. Server 110 may also execute a differential value generator 134 configured to analyze the list of available options, determine target options and program or preferred options, and generate a differential value 170.

Server 110 may communicate over a communications network 160 that may allow for communication between one or more computers 140A, 140B, and 140C accessible by users. Server 110 may also access a data store or database 120 that may store data pertaining to various medical information, medications, and insurance information. Server 110 may communicate with various other systems over network 160. The other systems may include systems associated with manufacturer 150, user or patient 153, and practitioner 155.

FIG. 1 illustrates that server 110 may receive information from manufacturers, practitioners, and pharmacies. FIG. 1 also illustrates that server 110 may generate a list of available options as well as a differential value 170. The generated list may be made available electronically over network 160 to computers 140A, 140B, and 140C prior to a patient arriving at a pharmacy or prior to the patient making a selection decision.

By processing the information at system 100, information may be provided to a user more efficiently. For example, data from the manufacturer, practitioner, and pharmacy may require accessing data using different formats and technologies, as well as different access methods and authentication. A provider that implements system 100 may provide greater efficiencies and security, while allowing a user to quickly and efficiently access medication information along with alternatives and cost information in a manner that has not previously been possible. Furthermore, the ability for the manufacturer or other provider to directly provide information such as differential values to a patient user is one that was not previously available. Server 110 may comprise a microprocessor and a memory. Furthermore, information may be stored at server 110 or database 120. System 100 may be configured to transmit data from the server 110 over a data channel to one or more of devices 140A, 140B, or 140C. An application executing on one of the devices 140A, 140B, or 140C such as a prescription viewer application may be used that causes the information to by displayed on the device, based on a connection from the device to the system 100 over network 160 (e.g., the Internet) when the user device is online. In some embodiments, system 100 addresses an Internet-centric challenge of providing real-time drug-related information to a patient user with time-sensitive information when the information is not otherwise accessible to the patient-user. This need may be addressed in some embodiments by transmitting the information, for example, over a wireless communication channel to the user-patient's device, which allows the user-patient's device to display the information that is received via the network 160.

In an embodiment, a process for entering information by a patient user may include using a computing device to log in to a secure server via a user interface such as a web browser. The patient user may proceed through an initial registration process, which may include, for example, selection of a user name and password. The process may further include entry of profile information, entry of insurance information, and contact information such as an email address.

The manufacturer's information may include, but not limited to: the manufacturer's product information, price information for each product, and the quantity of available products. The manufacturer may also be able to monitor progress with pharmacies and also provide information related to improvements and changes to drug programs.

The physician's information may include, but are not limited to: the physicians contact information (i.e. name, address, and telephone number), and prescription information for patients.

The pharmacy information may include, but not limited to: information pertaining to processing a prescription, information related to intervention if needed, and information related to coordination of benefits.

In various embodiments, the described system and method may generate results that can be presented to a patient prior to arriving at a pharmacy. The results may be presented to the patient in a variety of ways. Some examples of providing the results to the patient may include but are not limited to: at the physician's office, to the patient's mobile device, or at the pharmacy. The information may be presented on a computing device at the pharmacy, physician's office, or a patient's device, and accessed via a wired or wireless network connection. The timely access and presentation of information can allow the patient to be more informed of the prescription options that are available as well as the accompanying pricing information for each prescription option.

In some embodiments, the system and method may provide the patient with an additional data element that indicates a differential value that may be applied to one or more of the prescription options. Such a differential value may be determined by a manufacturer or provider of one of the prescription options. In an embodiment, the differential value may represent an advantage amount, an advantage discount, or a cost incentive that the manufacturer or provider may provide in order to offset differences in cost as compared to other prescription options. For example, the differential value may be presented as a discount coupon or discount code for a selected medication that is presented as an option for a prescribed medication. The discount coupon or discount code may be represented as data that may be rendered on a display device or printed, and may be presented to the patient in a variety of ways, such as on a computing device at the pharmacy, physician's office, or a patient's device.

The differential value provided by the manufacturer or provider may be effectively presented to a patient prior to the patient's selection of a prescription option in order to allow for consideration of the differential value along with the various presented prescription options. The differential value may be selected so as to place the associated product in a more competitive position as compared to products from other manufacturers and providers.

In some embodiments, the system and method may utilize the information from manufacturer, the physician, and the patient to generate and present a tailored plan for the medications prescribed by the physician. The plan may be provided as a coverage report or other format.

In one embodiment, the differential value may be determined as a monetary value (e.g. $10.00) or a percentage (e.g. 10.00%). The value and percentage may be mutually exclusive, where if a value amount is selected, then a percentage value is not selected. For example, if the value amount is $10.00, then the percentage value may be set to null. Similarly, if the percentage value is 10.00%, then the value amount is may be set to null. In some embodiments, a maximum value or maximum percentage may be set for a selected product.

In an embodiment, the system may be configured to access or receive the National Drug Code (NDC) to identify drug products for adjudication and associated reversal. The system may be configured to determine a patient or member's cost or pay amount for each drug. A patient may be referred to as a user if the patient is accessing the system for participation in the program. The patient may also be referred to as a member when participation in the program includes registration and/or other criteria for participation. The system may calculate the differential value for a selected drug. A selected drug may also be referred to as a sponsored drug when the drug is identified by the manufacturer or provider for promotion through use of a differential value. A target drug may be a drug that is identified as one in response to which a sponsored drug may incorporate a differential value for promotion.

In an embodiment, if the member's pay amount for a sponsored drug is less than the member's pay amount of all target drugs, then the system may be configured to not generate a differential value in conjunction with as part of the coverage report (i.e., just generate the coverage report). Otherwise, the system may calculate the differential value (e.g., coupon value).

In one embodiment, the system may be configured to calculate the difference between the patient pay amount of the sponsored drug as compared to the lowest patient pay amount of associated target drug(s). The system may determine if a differential value comprising a monetary value or if a differential value comprising a percentage value is established for the program. If a monetary value was specified, then the differential value (e.g., coupon value) may be set as equal to the amount of the difference plus the amount of the monetary value.

If the differential value is greater than the specified differential value maximum amount, then make the differential value may be set to be equal to the differential value maximum amount. If a percentage value was specified, then the system may determine the lowest patient pay amount of all associated target drugs. The system may then calculate the differential value as the lowest patient pay amount multiplied by the advantage percentage value. The differential value may be set as equal to the amount of the difference plus the amount discount. If the differential value is greater than the specified maximum differential value amount, then the differential value may be set as equal to the specified maximum differential value amount.

The system may be configured to send, or make available to the patient or user, information generated by the system. The information may include an accounting of all pertinent drugs and their co-pay/costs. In some embodiments, the preferred formulary items may be highlighted. The information may also include a differential value if applicable. The information may include enrollment information in this or other programs, as well as notifications as needed. The information may also include pharmacy information such as name and location.

The system may be configured to provide the information via a user interface such as on a web browser. The information may also be provided via a programming interface. The system may be configured to send messages such as by email or text messages. The system may also be configured to send or receive information via analogue means such as fax machines. The system may be configured to process requests, access and process data, and provide the information to the patient in a timely manner so as to enable the patient to access and view available options quickly and in real-time, such as when the patient is in a physician's office.

The described system and method may allow drug manufacturers and providers with a way to communicate with patient users and provide incentives via the use of differential values. In some embodiments, the system and method may be implemented by an entity other than the manufacturer. For example, a third party service may be provided that implements the described system and method. The entity providing the third party service may charge a license fee, for example, for each drug category, on a per claim basis, or per report. The entity providing the third party service may also charge for developing, processing, and providing the differential values. The entity may also charge for advanced managed care data. As described herein, a system that implements the described methods may be referred to as the “system” regardless of whether the service is provided by the manufacturer or a third party service.

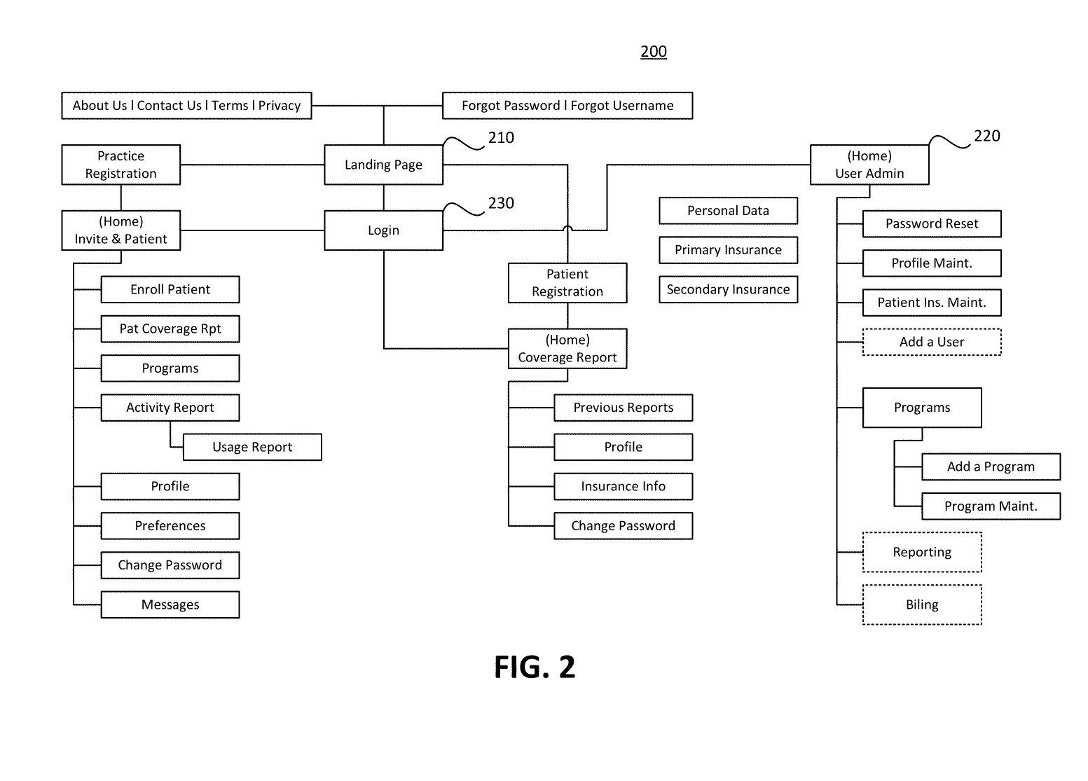

FIG. 2 illustrates an example structure for components of a system for providing medical information in accordance with some embodiments. The structure may be implemented in some embodiments as a computing system executing application software. FIG. 2 illustrates a landing page 210 that may be configured to provide a starting point for accessing and entering information. User administration starting page 220 may be configured to provide a starting point for various administration entry and management functions such as user profile management and billing information. Login starting page 230 may be configured to provide a starting point for various user registration and management functions such as user profile enrollment and management.

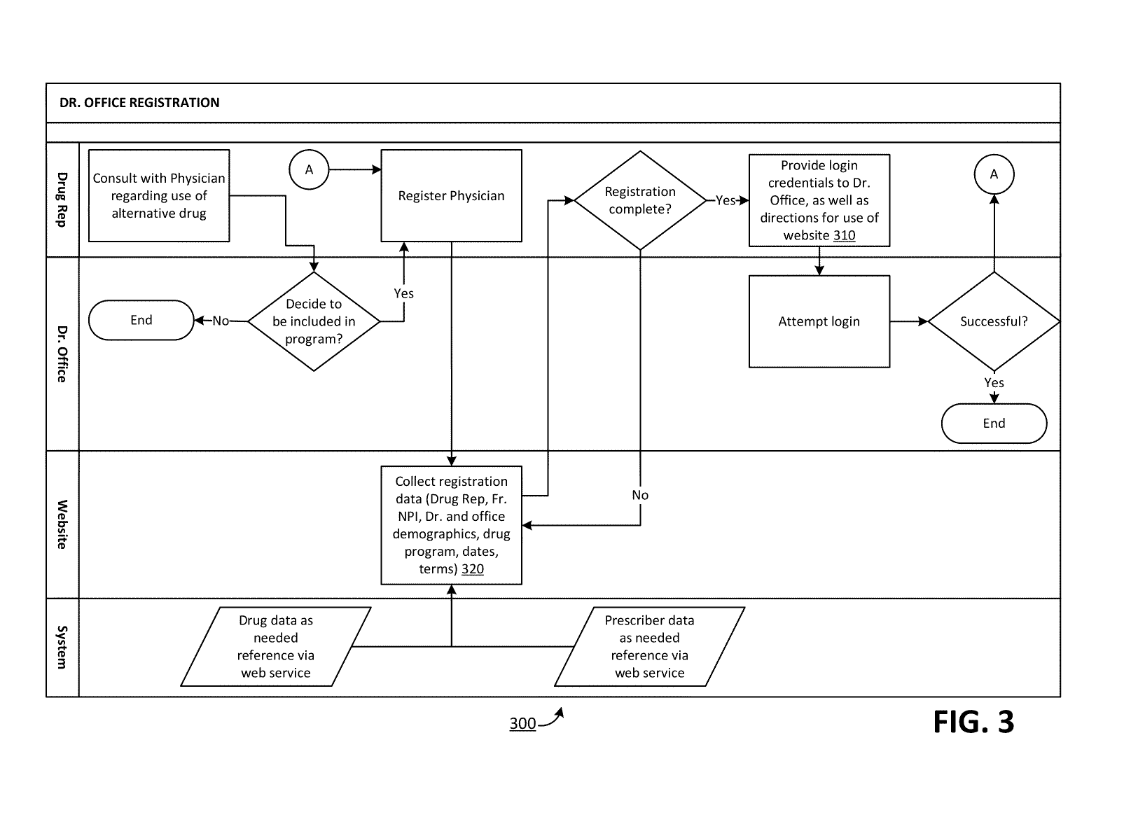

FIG. 3 illustrates an example diagram illustrating a process 300 for processing medical information for a practitioner in accordance with some embodiments. FIG. 3 illustrates process 300 that may include accessing and entering information for a practitioner such as a physician's office. Login credentials for a practitioner as well as directions for use of website may be provided 310. Registration data (such as drug representative, NPI, physician and office demographics, drug program, dates, terms, etc.) may be collected 320.

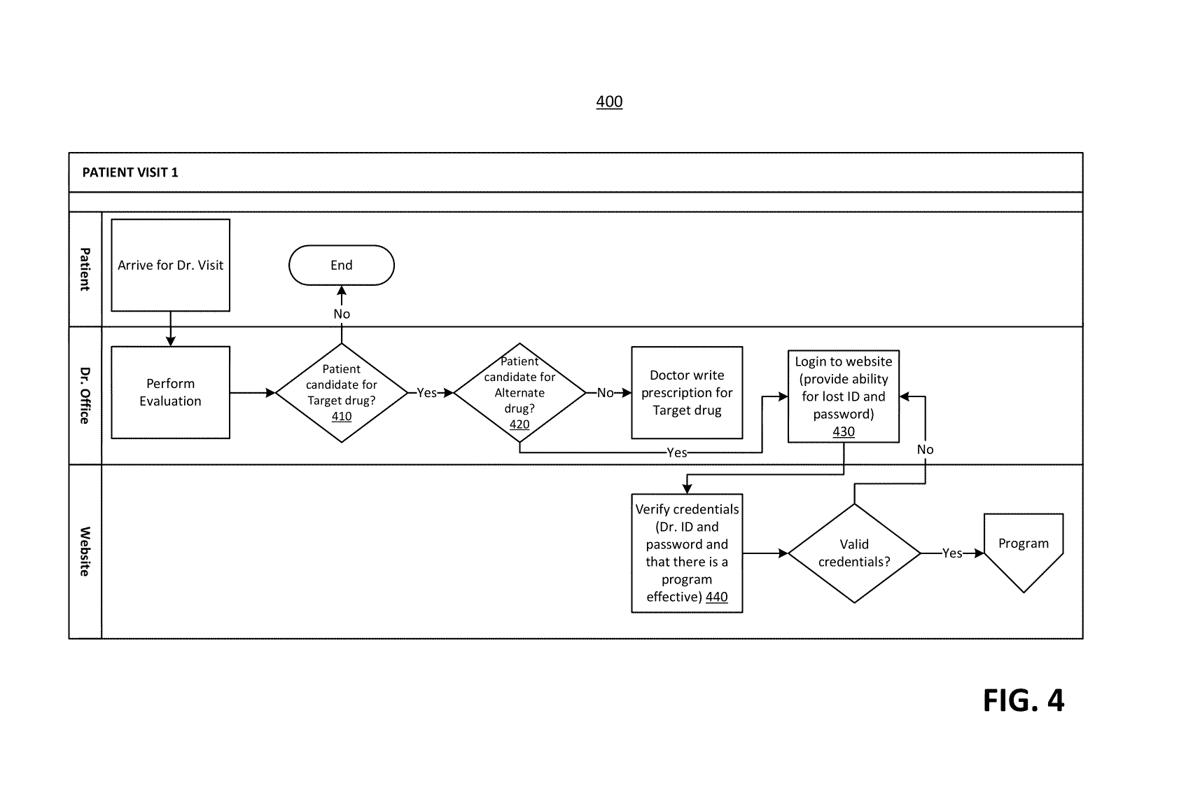

FIG. 4 illustrates an example diagram illustrating a process 400 for processing medical information at a practitioner's location in accordance with some embodiments. FIG. 4 illustrates a process for determining that a patient is a candidate for a target drug 410 or an alternate drug 420. The physician or other use may login to a website 430. Credentials such as a physician ID and password may be verified and existence of an effective program may be determined 440.

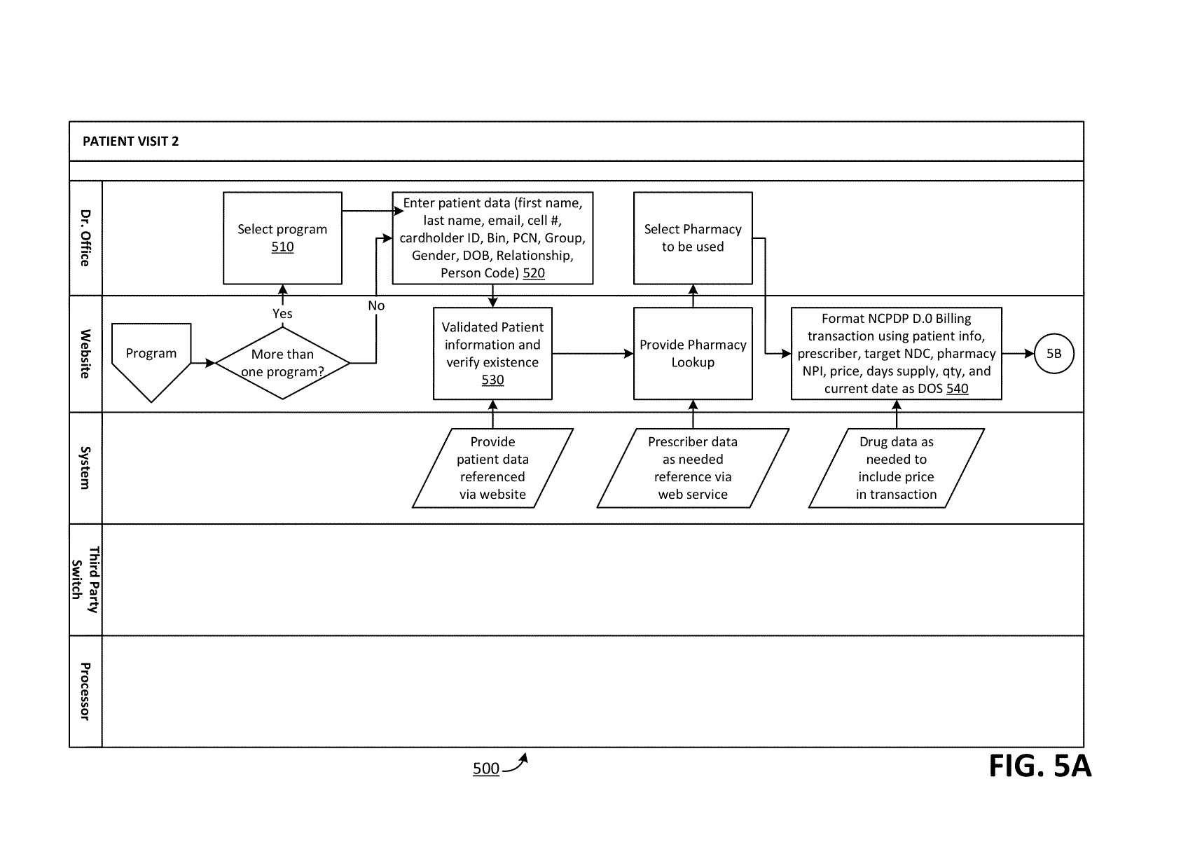

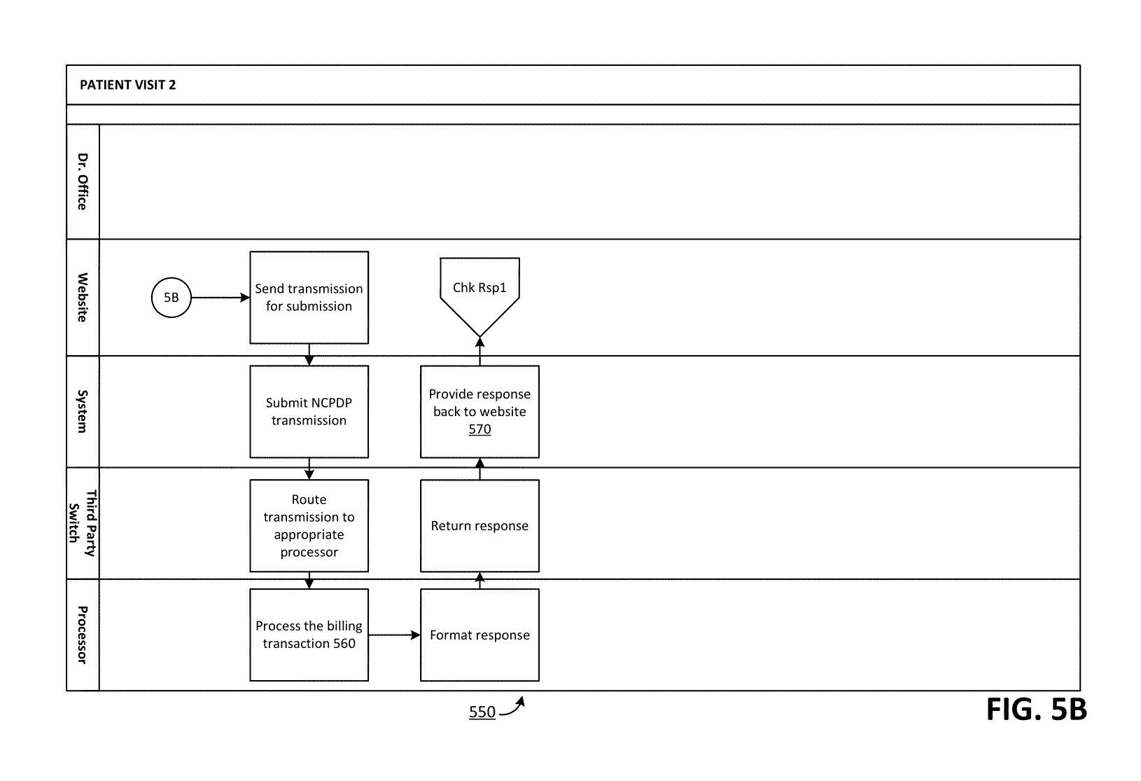

FIG. 5A illustrates an example diagram illustrating an additional process 500 for processing medical information in accordance with some embodiments. FIG. 5A illustrates processes such as selecting a program 510, and entering patient data 520 (e.g., first name, last name, email, cell #, cardholder ID, Bin, PCN, Group, Gender, DOB, Relationship, Person Code). The system providing the processing may validate patient information and verify the program 530. The system may also format NCPDP D.0 Billing transaction using patient information, prescriber, target NDC, pharmacy NPI, price, days supply, quantity, and current date as DOS 540.

FIG. 5B illustrates additional example processes 550 for processing medical information in accordance with some embodiments. FIG. 5B illustrates processes such as processing the billing transaction 560 and providing a response to the website 570.

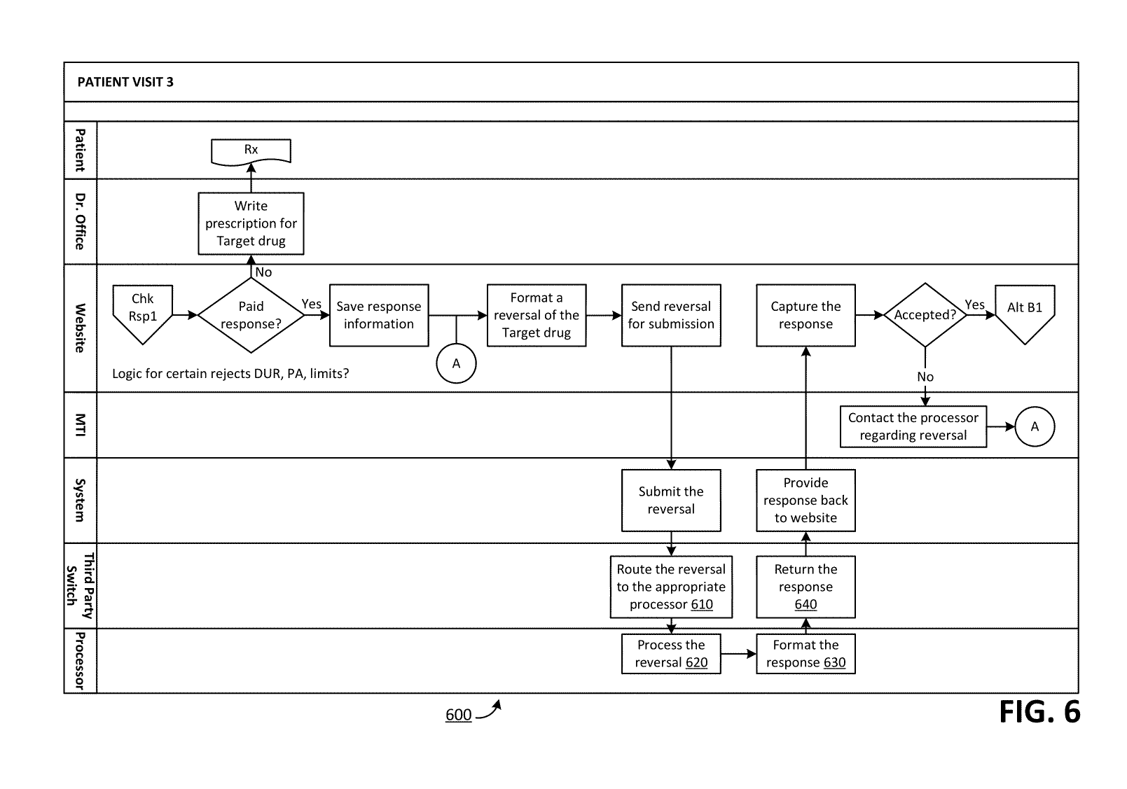

FIG. 6 illustrates an example diagram illustrating further processes 600 for processing medical information in accordance with some embodiments. FIG. 6 illustrates processes such as routing a reversal to an appropriate processor 610 and processing the reversal 620. FIG. 6 also illustrates formatting the response 630 and returning the response 640.

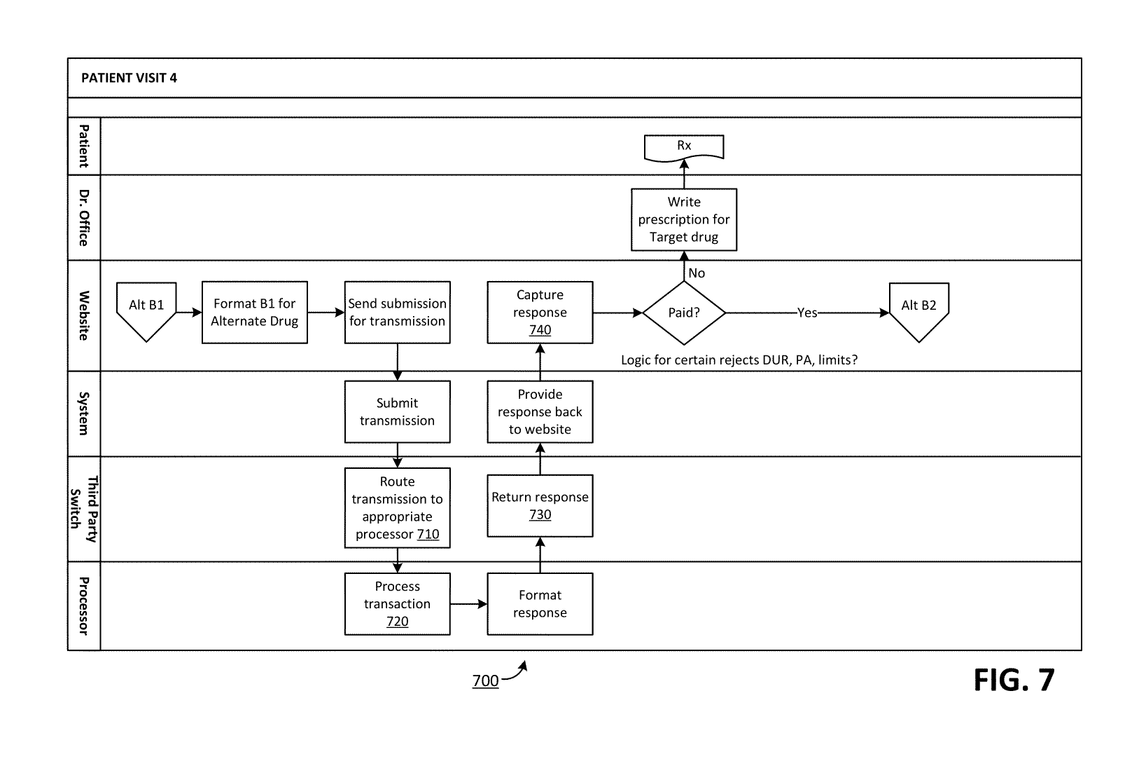

FIG. 7 illustrates an example diagram illustrating further processes 700 for processing medical information in accordance with some embodiments. FIG. 7 illustrates operations such as routing a transmission to an appropriate processor 710 and processing a transaction 720. FIG. 7 also illustrates returning the response 730 and capturing the response 740.

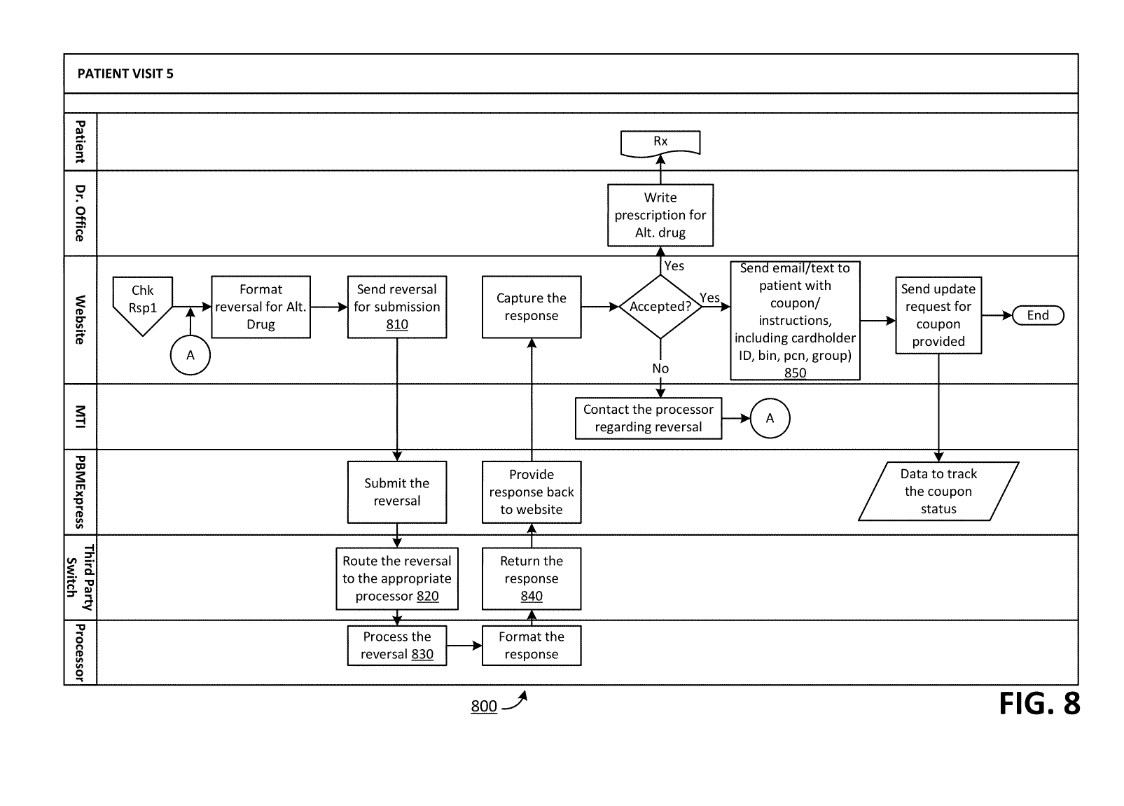

FIG. 8 illustrates an example diagram illustrating further processes 800 for processing medical information in accordance with some embodiments. FIG. 8 illustrates operations such as sending a reversal for submission 810. FIG. 8 also illustrates routing the reversal to the appropriate processor 820 and processing the reversal 830. FIG. 8 also illustrates sending an email or text message to the patient with coupon/instructions 850.

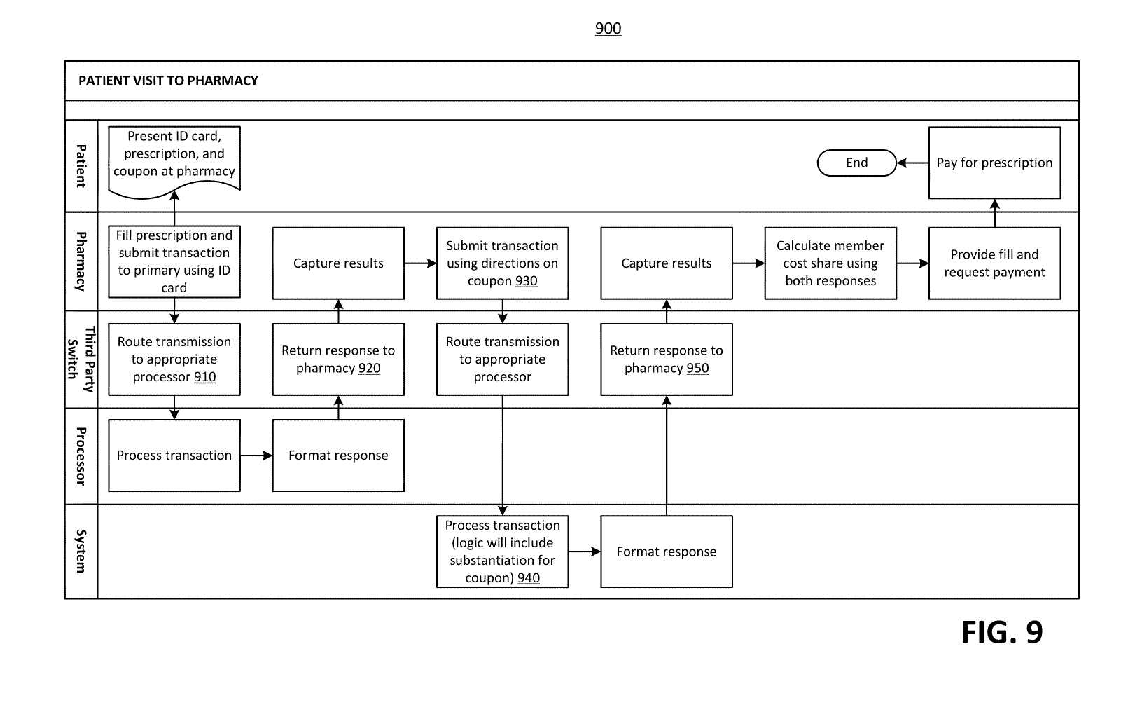

FIG. 9 illustrates an example diagram illustrating further processes 900 for processing medical information in accordance with some embodiments. FIG. 9 illustrates routing a transmission to appropriate processor 910. FIG. 9 illustrates returning a response to the pharmacy 920. FIG. 9 illustrates submitting a transaction using directions on the coupon 930. FIG. 9 illustrates processing a transaction including, in some embodiments, substantiation for the coupon 940. FIG. 9 also illustrates returning a response to the pharmacy 950.

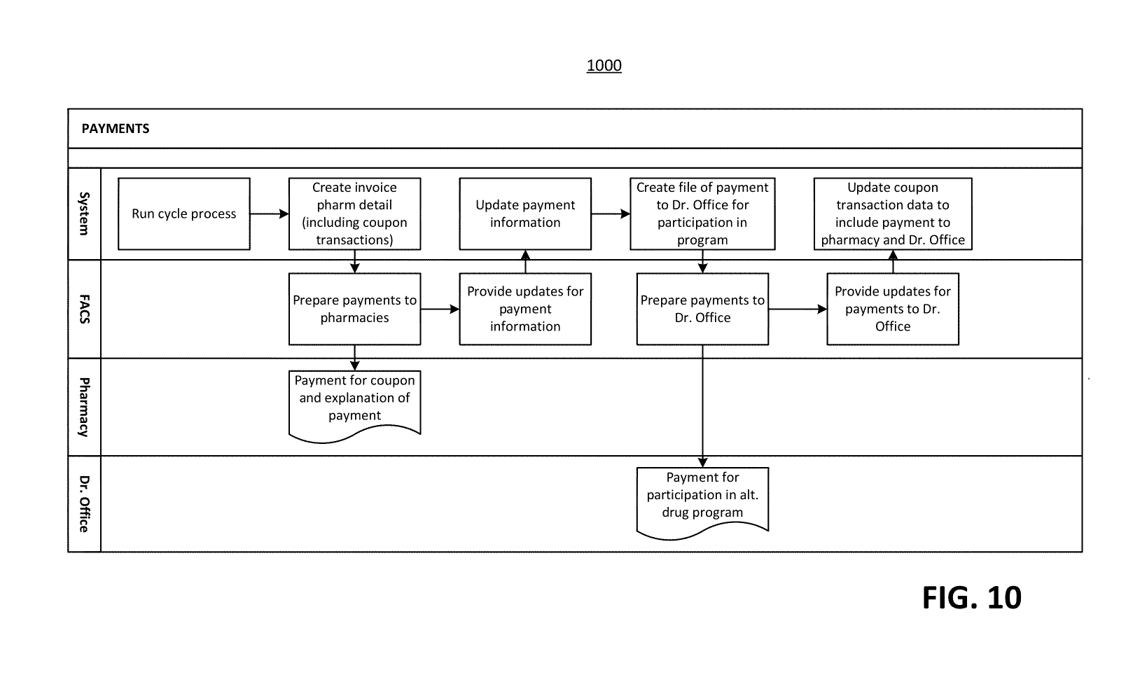

FIG. 10 illustrates an example diagram illustrating further processes 1000 for processing medical information in accordance with some embodiments. FIG. 10 illustrates operations for payments to various parties including the pharmacy and physician's office.

FIG. 11 illustrates a user interface 1100 and operations for providing medical information in accordance with the present disclosure. FIG. 11 illustrates information pertaining to entry of information for a sponsored drug. Information may include, for example, the 11-digit NDC of a specified drug, trade name of the specified drug, strength of the specified drug, dosing form of the specified drug, quantity dispensed expressed in metric decimal units, name of the sponsor drug's manufacturer (e.g., program sponsor), and internet address associated to the sponsor drug.

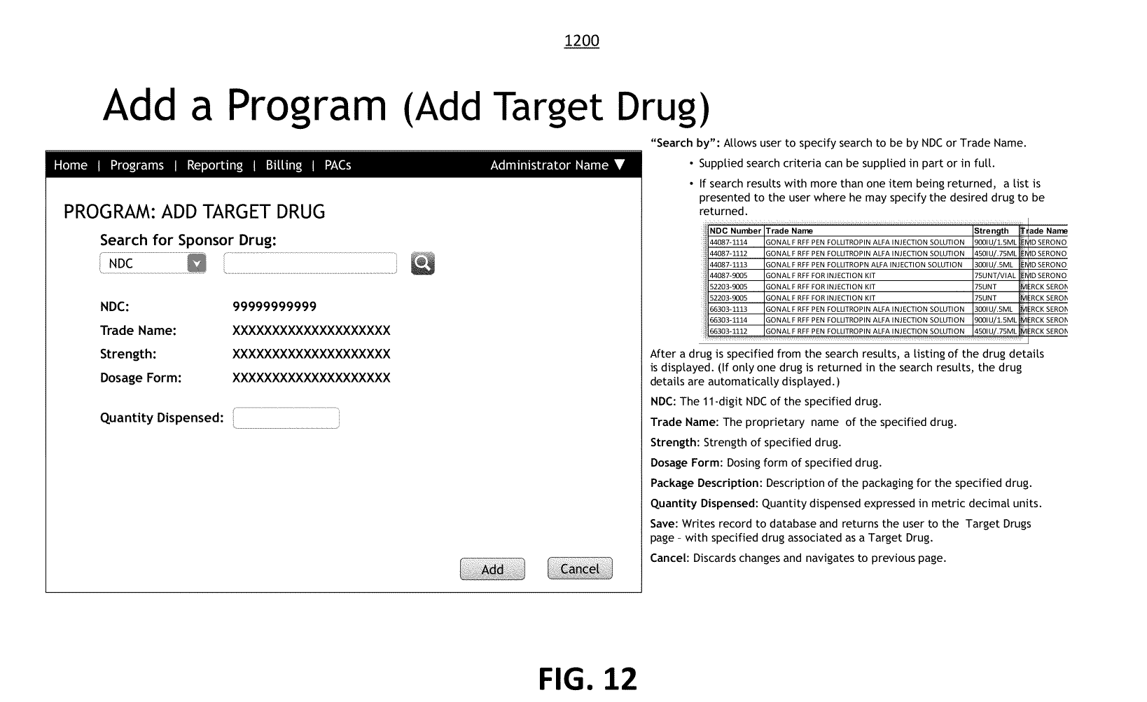

FIG. 12 illustrates a user interface 1200 and operations for providing medical information in accordance with the present disclosure. FIG. 12 illustrates information pertaining to entry of information for a target drug. Information may include, for example, the 11-digit NDC of a specified drug, proprietary name of the specified drug, strength of the specified drug, dosing form of the specified drug, quantity dispensed expressed in metric decimal units, and a description of packaging.

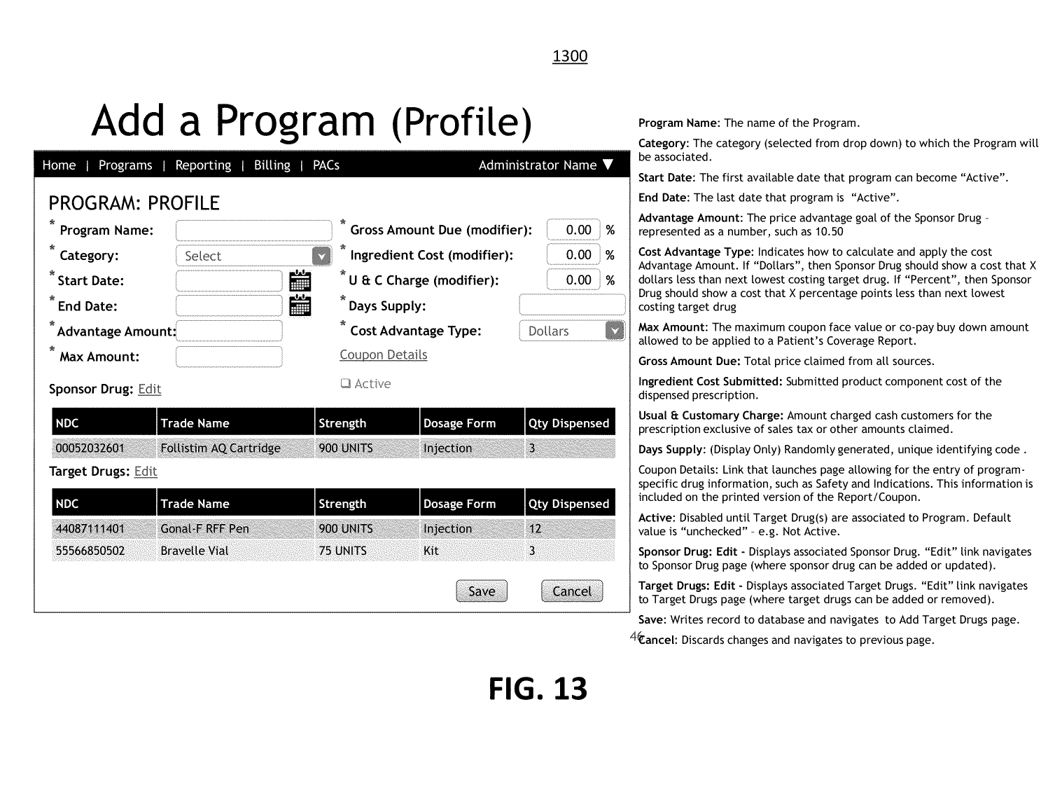

FIG. 13 illustrates a user interface 1300 and operations for providing medical information in accordance with the present disclosure. FIG. 13 illustrates information pertaining to entry of a program profile. Information may include, for example, the name of the program, the category to which the program will be associated, the first available date that program can become active, the last date that the program is active, differential value or advantage amount, which in some embodiments may be represented as a number, such as 10.50, and cost advantage type, indicating how to calculate and apply the cost advantage amount. For example, if the type is “dollars,” then the sponsor drug may have a cost that is X dollars less than the next lowest cost target drug. If the type is “percent,” then the sponsor drug may have a cost that is X percentage points less than the next lowest cost target drug. The information may also include the maximum coupon face value or co-pay buy down amount allowed to be applied to a patient's coverage report, the total price claimed from all sources, the submitted product component cost of the dispensed prescription, the amount charged cash customers for the prescription exclusive of sales tax or other amounts claimed, the days supply, a unique identifying code, and a link for a web page allowing for the entry of program-specific drug information, such as safety and indications.

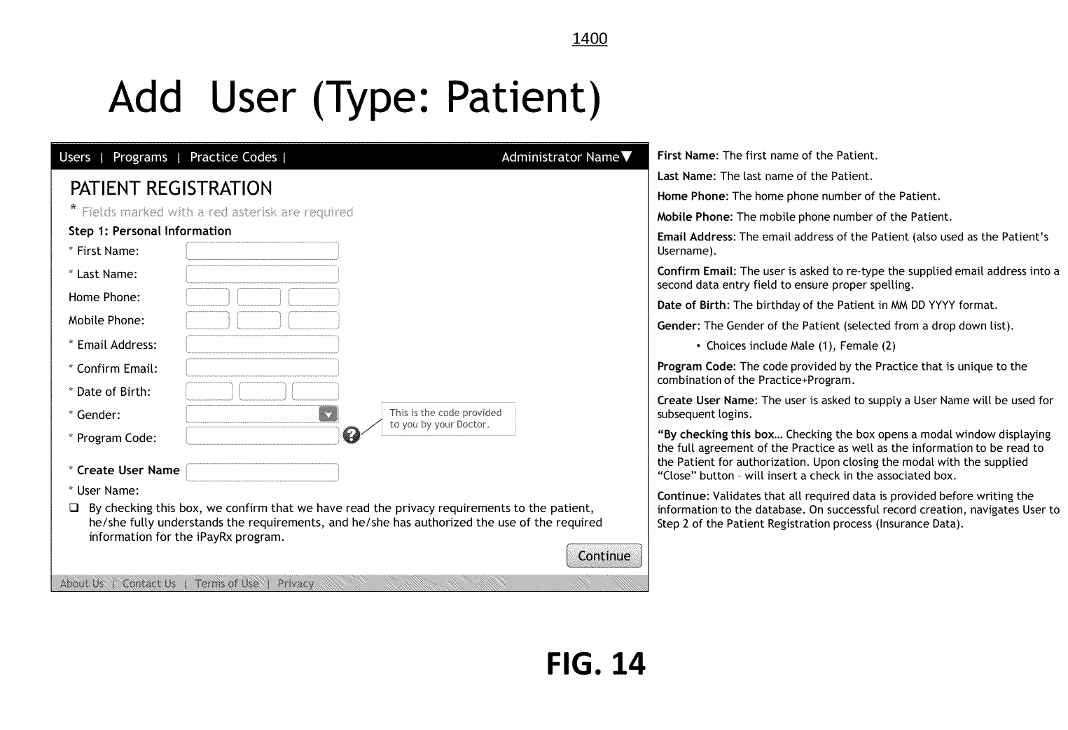

FIG. 14 illustrates a user interface 1400 and operations for providing medical information in accordance with the present disclosure. FIG. 14 illustrates information pertaining to entry of information for a patient user. Information may include, for example, personal information for a user and a program code provided by the practice that is unique to the combination of the practice and program.

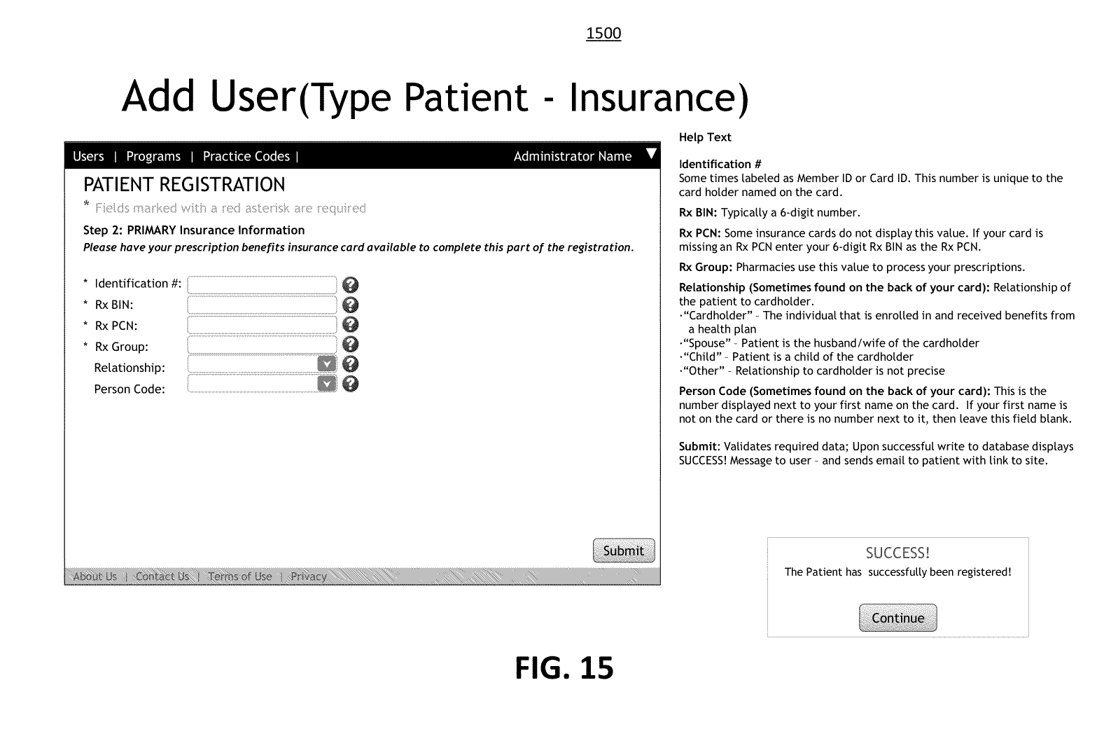

FIG. 15 illustrates a user interface 1500 and operations for providing medical information in accordance with the present disclosure. FIG. 15 illustrates information pertaining to entry of insurance information for a patient user. Information may include, for example, identification information such as a member ID or card ID, RX bin number, RX PCN, RX group, relationship of the patient to cardholder, the individual that is enrolled in and receives benefits from a health plan, and other family information.

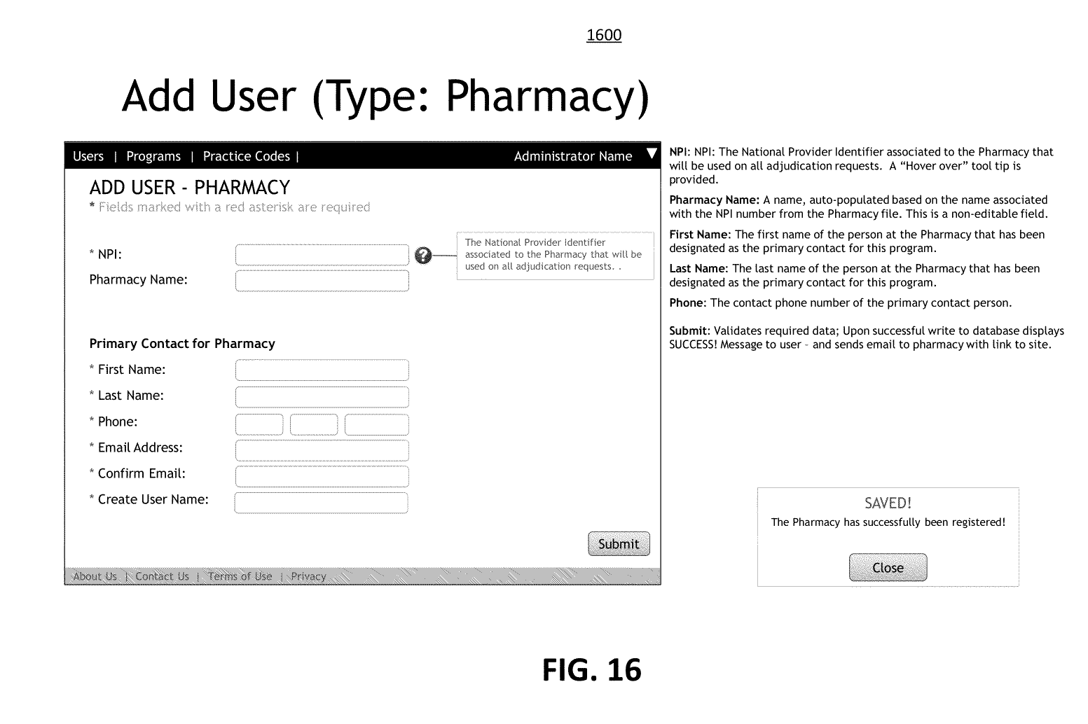

FIG. 16 illustrates a user interface 1600 and operations for providing medical information in accordance with the present disclosure. FIG. 16 illustrates information pertaining to entry of information for a pharmacy. Information may include, for example, the National Provider Identifier (NPI) associated to the pharmacy for adjudication requests, the pharmacy name, the pharmacy primary contact, and the contact phone number.

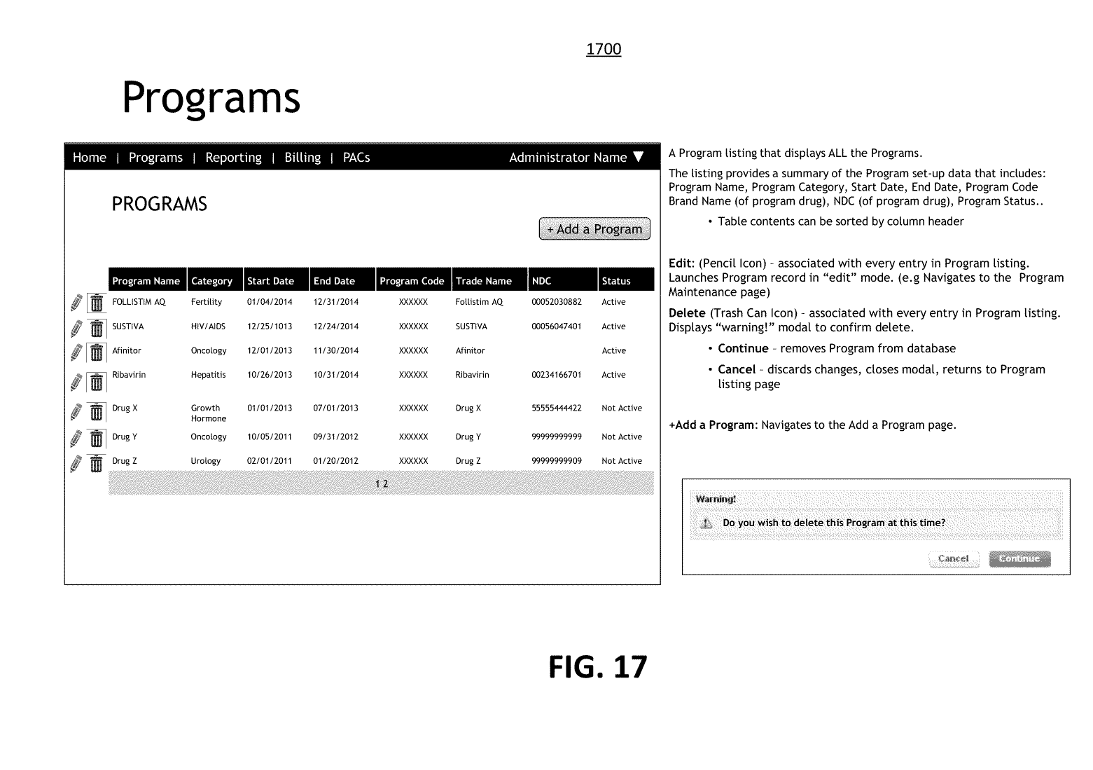

FIG. 17 illustrates a user interface 1700 and operations for providing medical information in accordance with the present disclosure. FIG. 17 illustrates information pertaining to entry of program information. Information may include, for example, program set-up data that may include program name, program category, start date, end date, program code brand name (of program drug), NDC (of program drug), and program status.

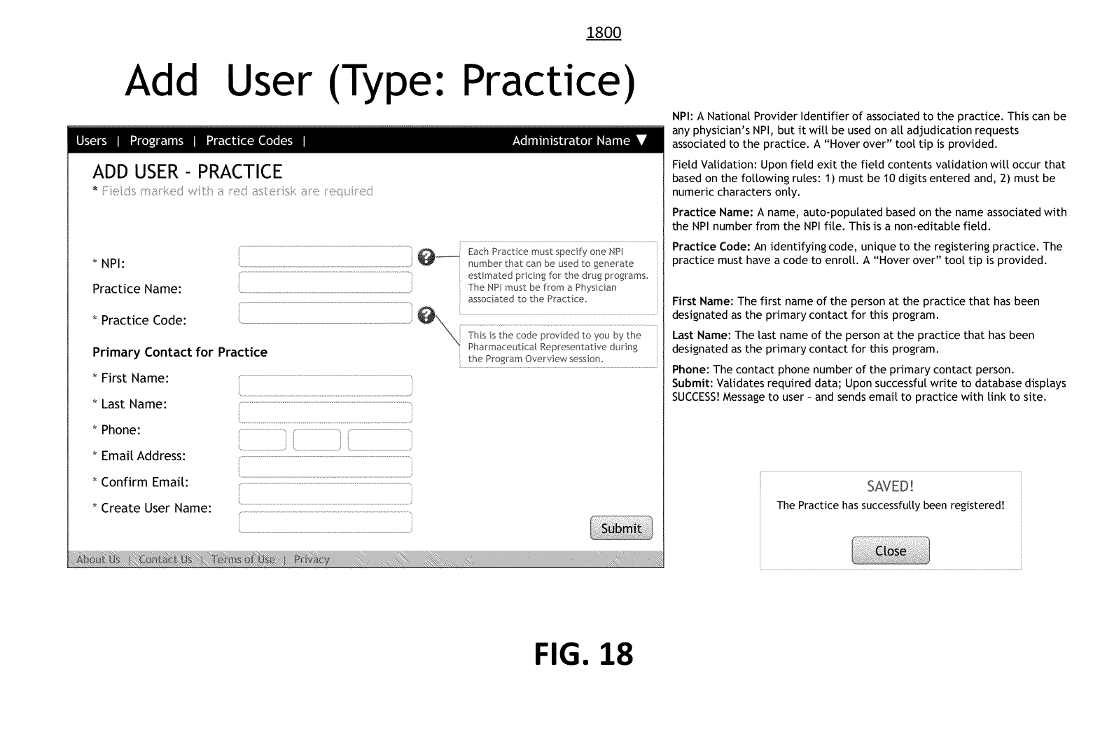

FIG. 18 illustrates a user interface 1800 and operations for providing medical information in accordance with the present disclosure. FIG. 18 illustrates information pertaining to entry of practice information for a user. Information may include, for example, a National Provider Identifier (NPI) associated to the practice, practice name based on the name associated with the NPI number from the NPI file, and a practice code unique to the registering practice.

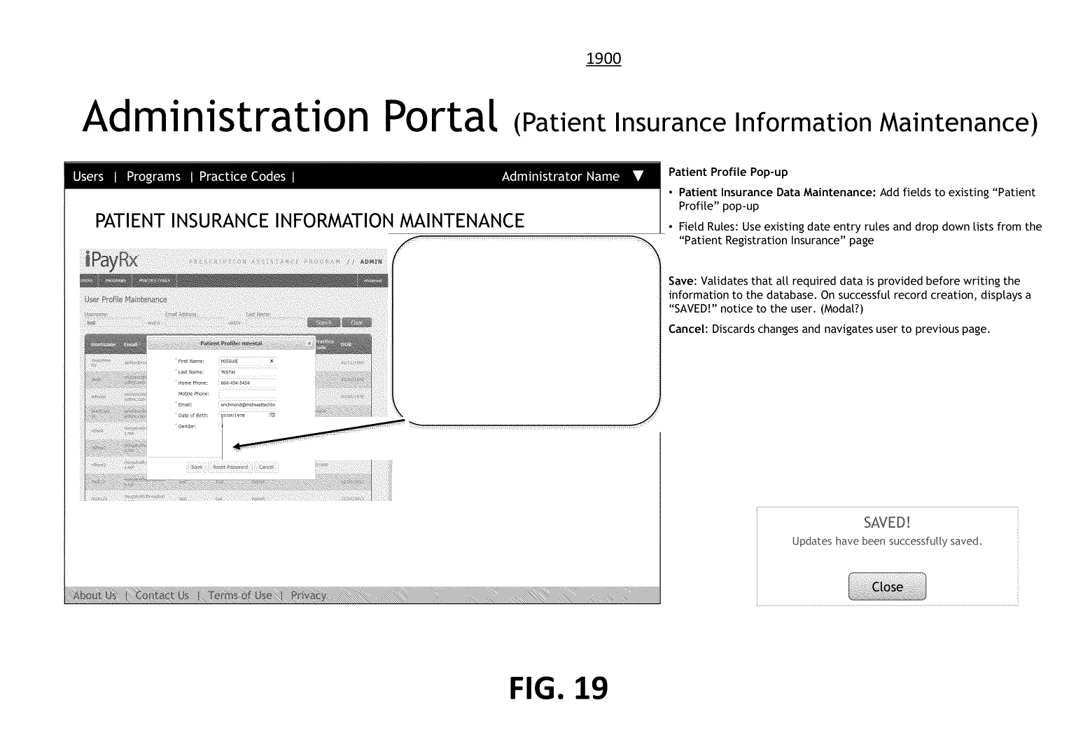

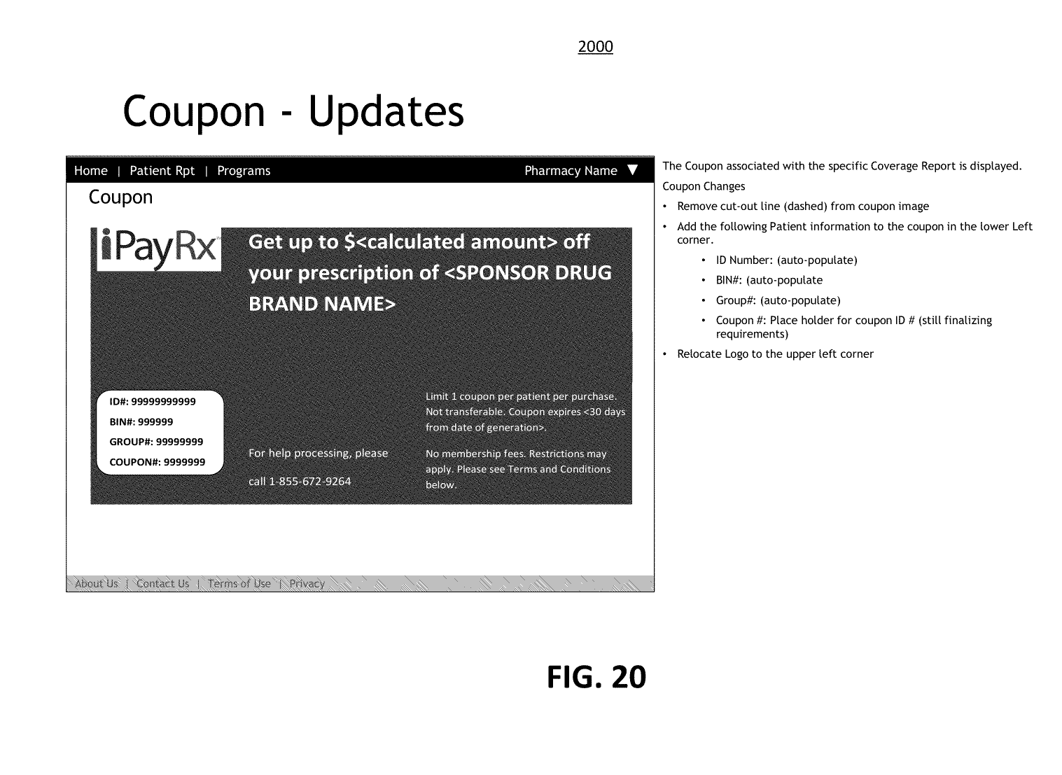

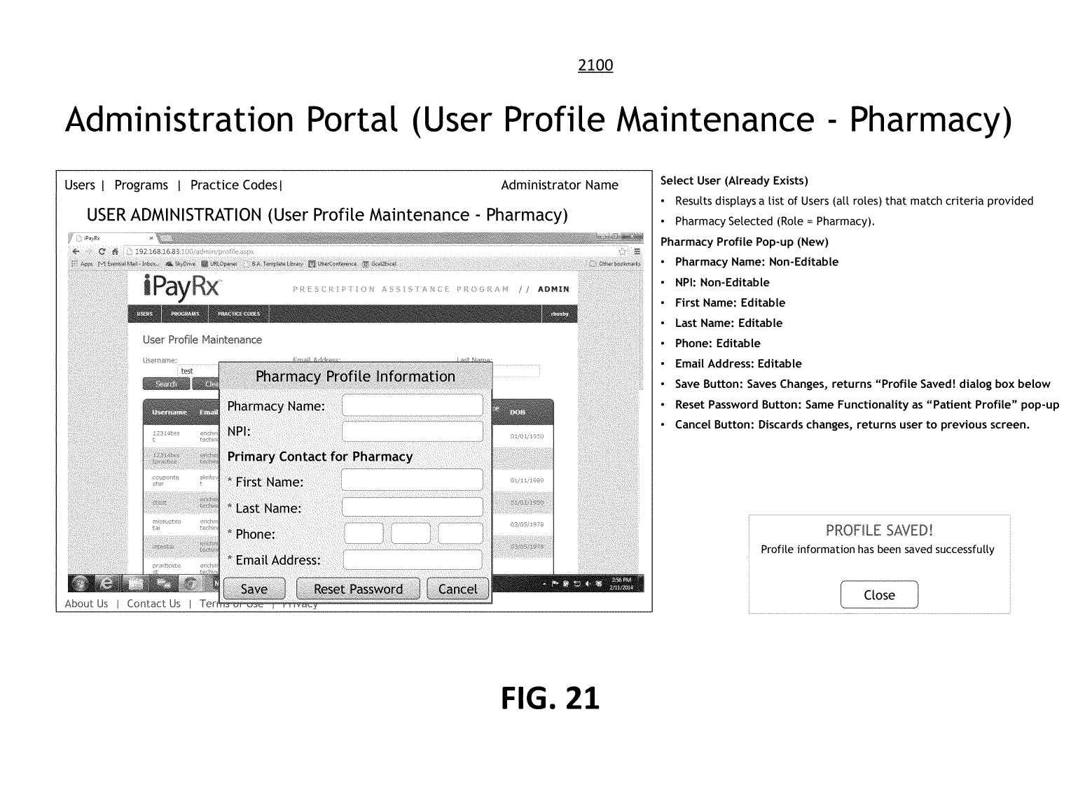

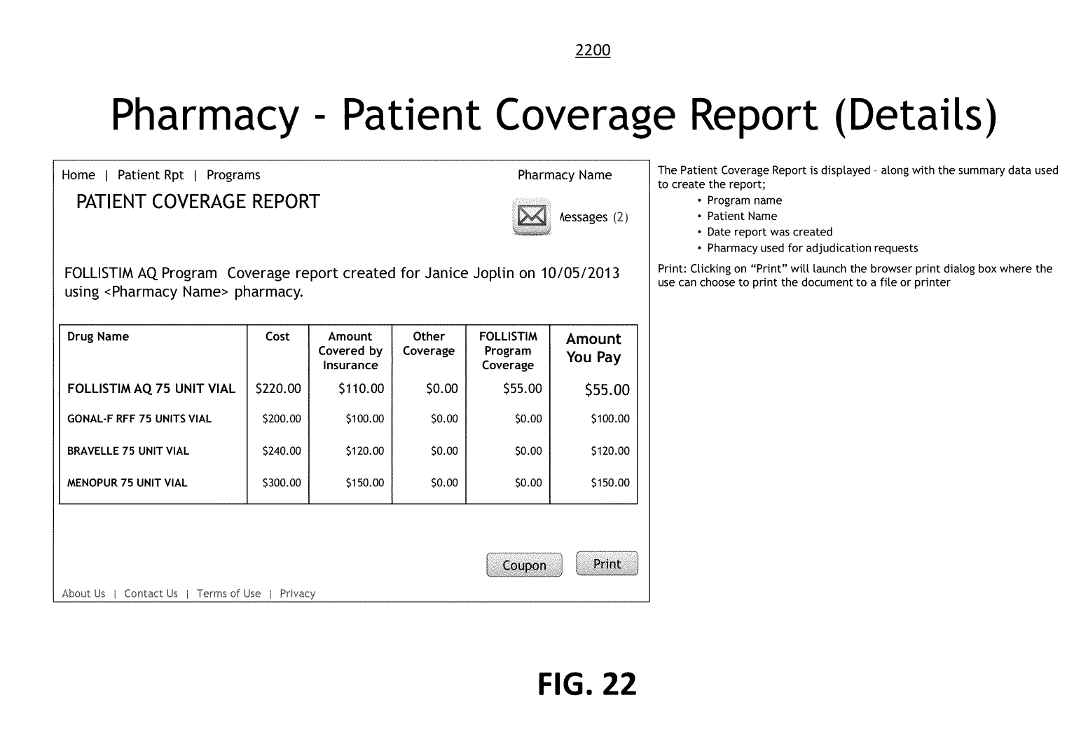

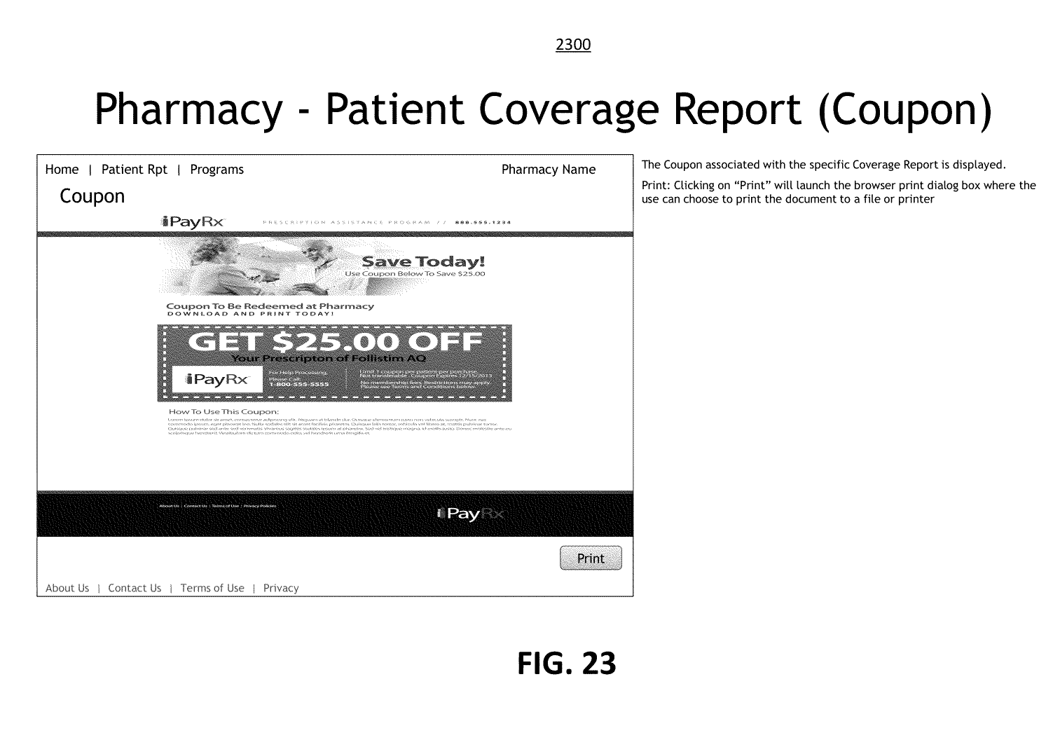

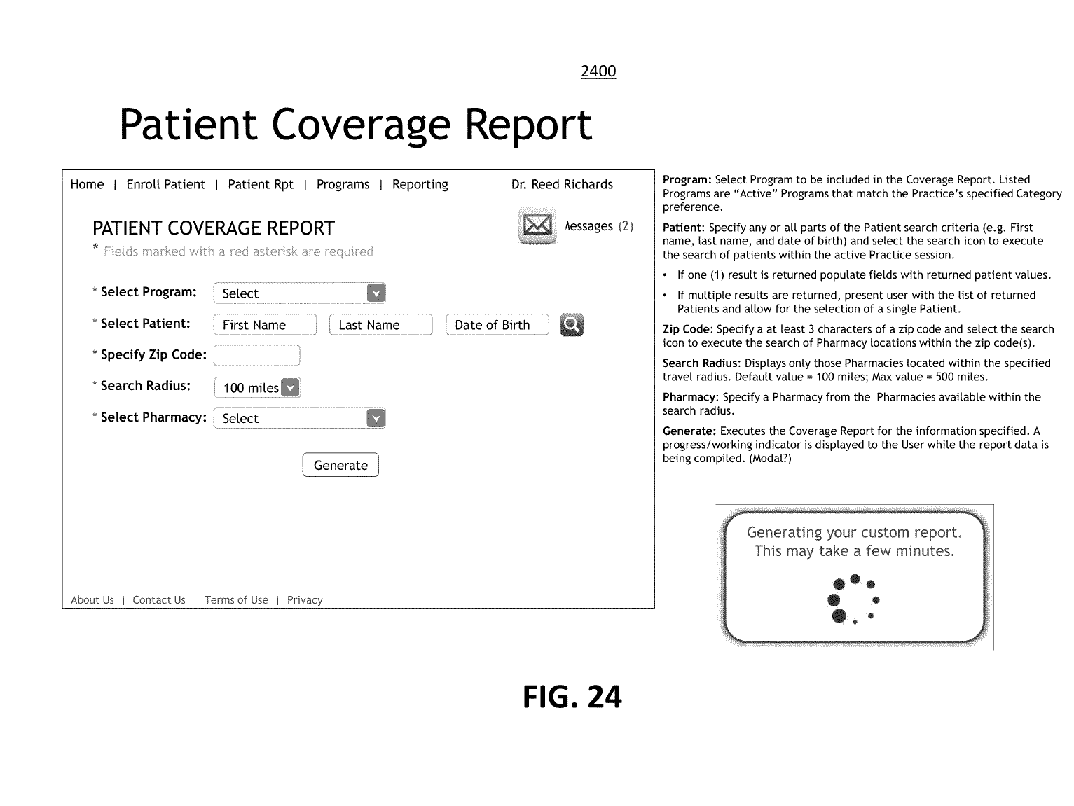

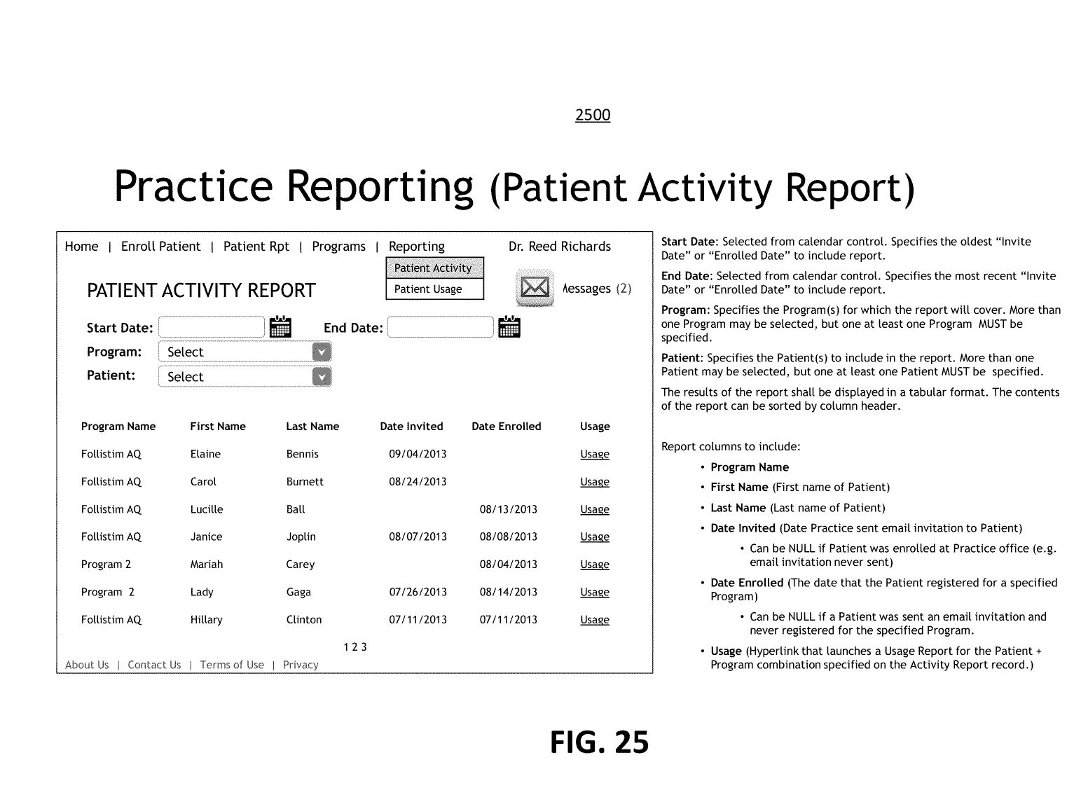

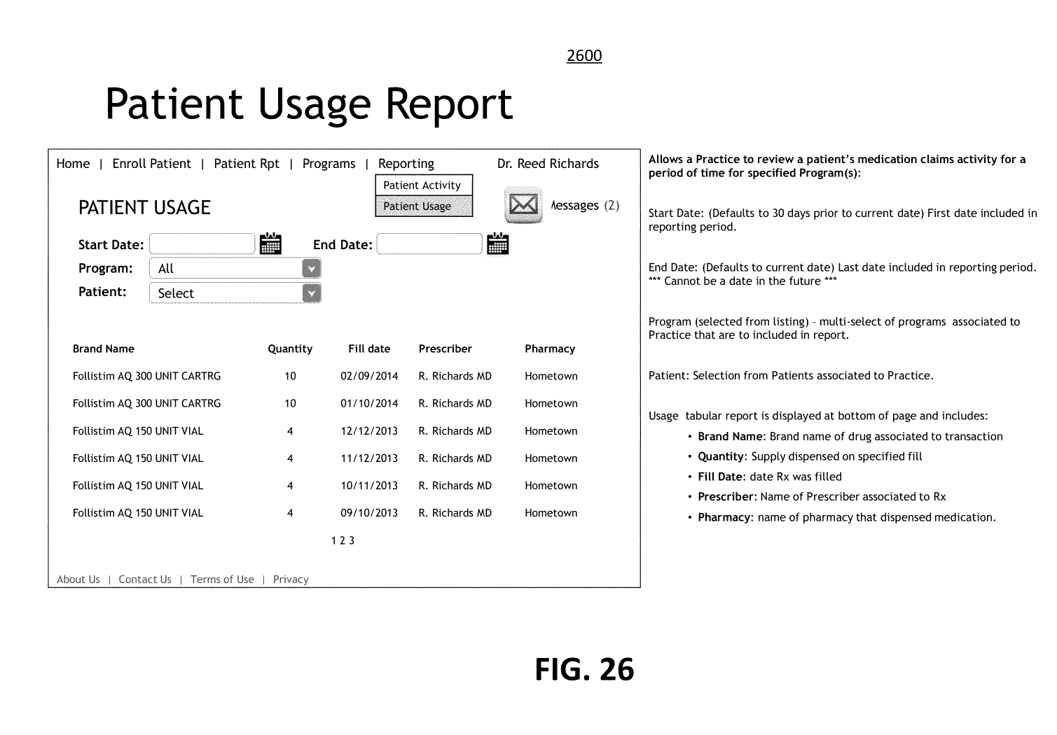

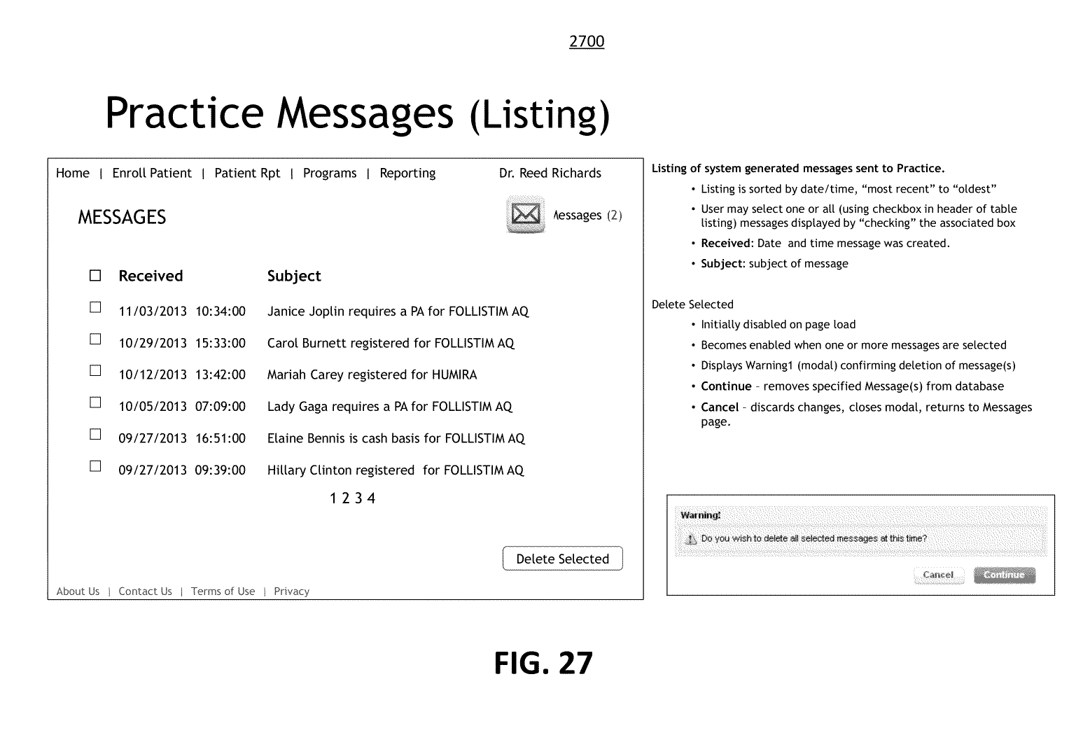

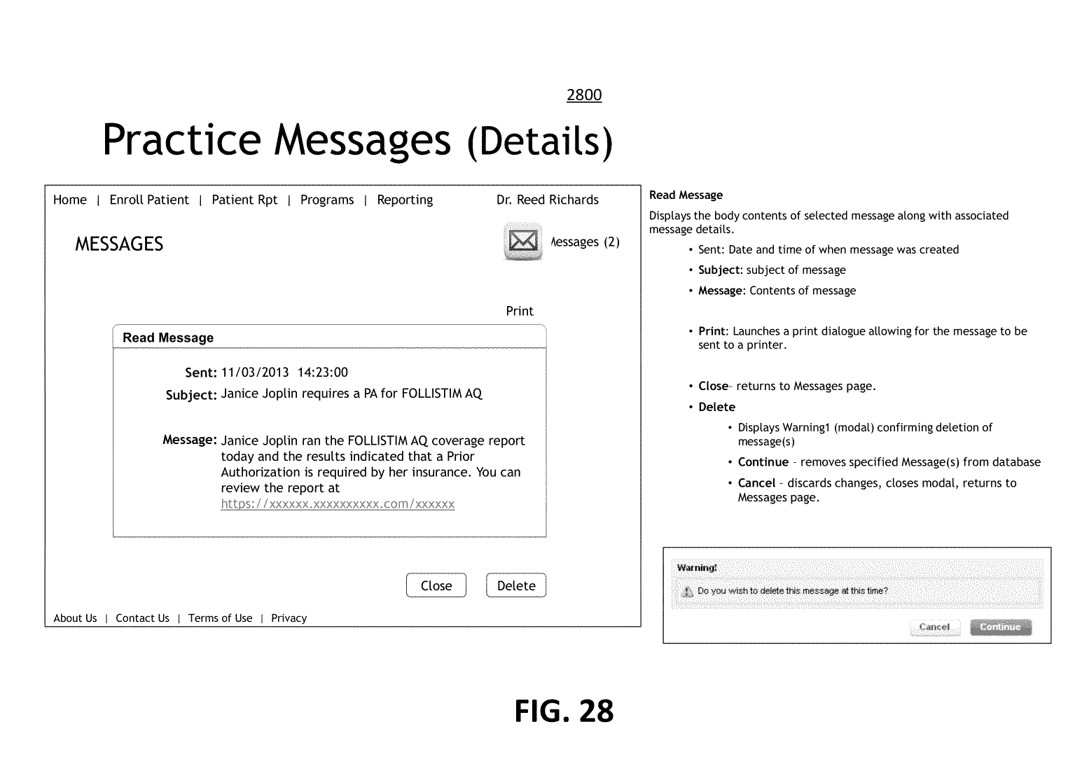

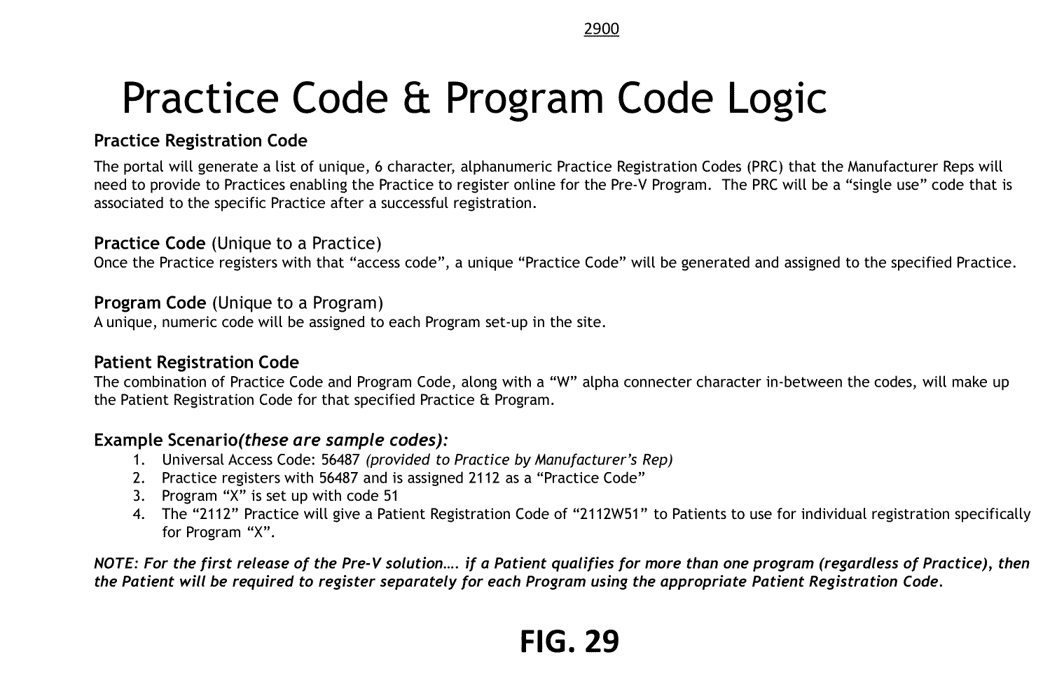

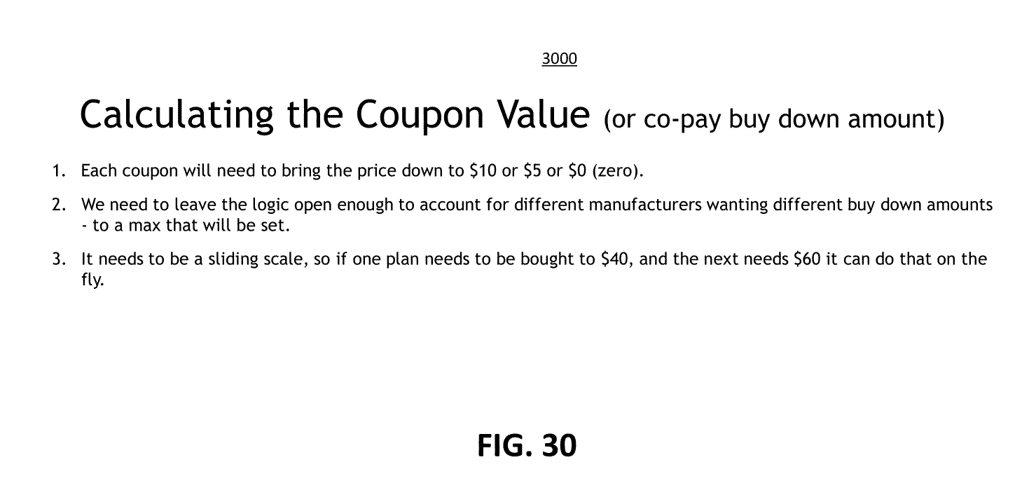

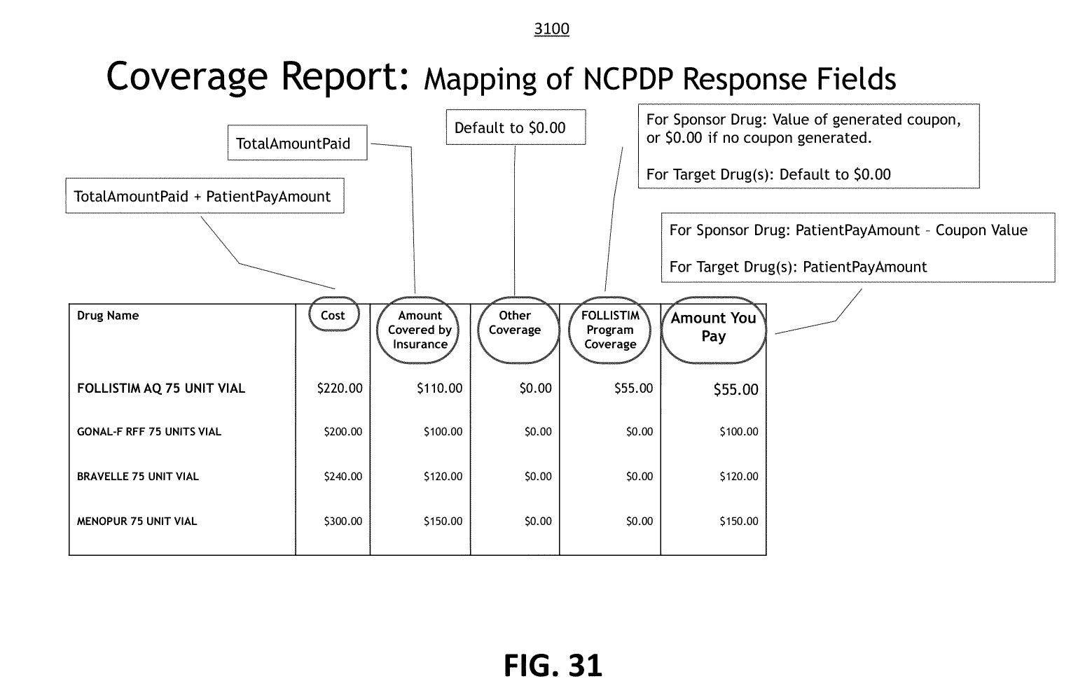

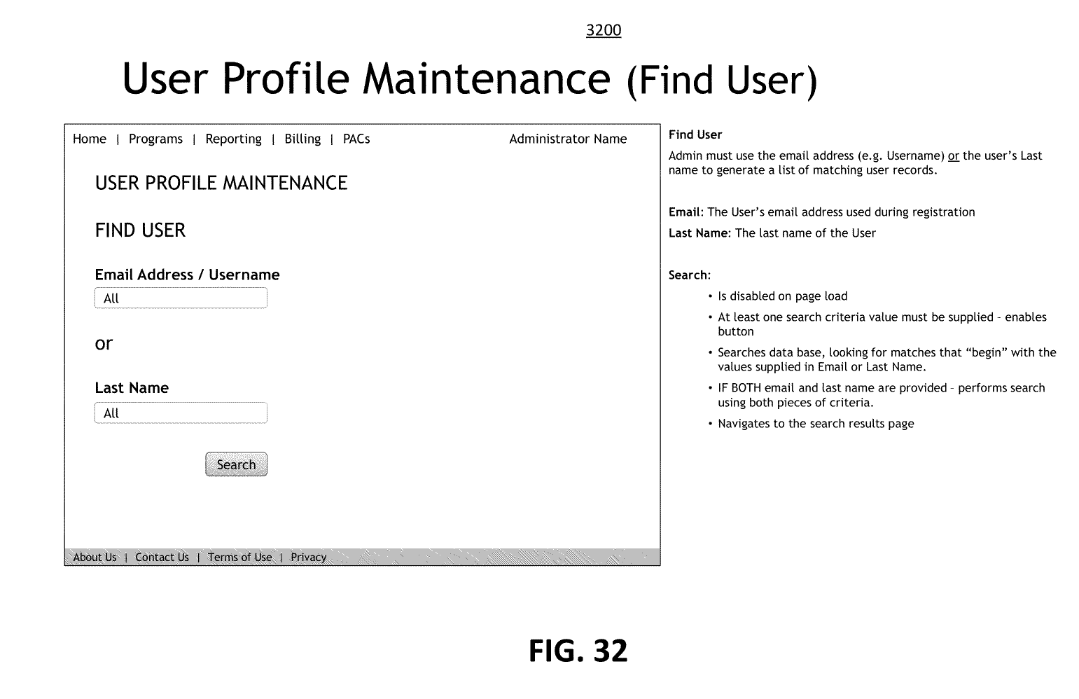

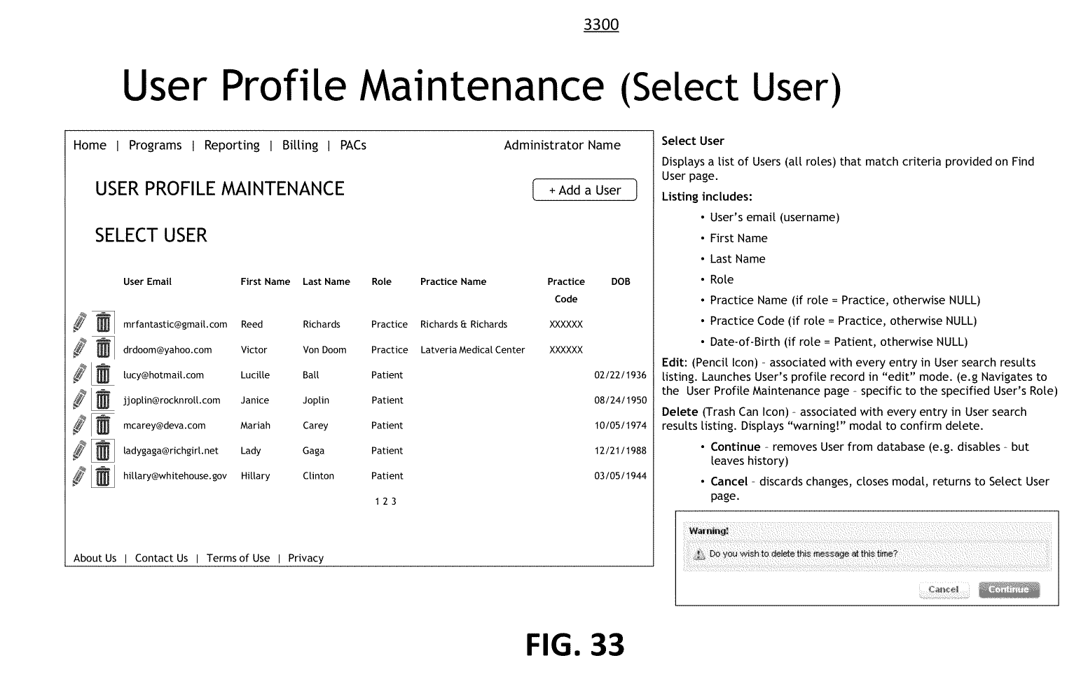

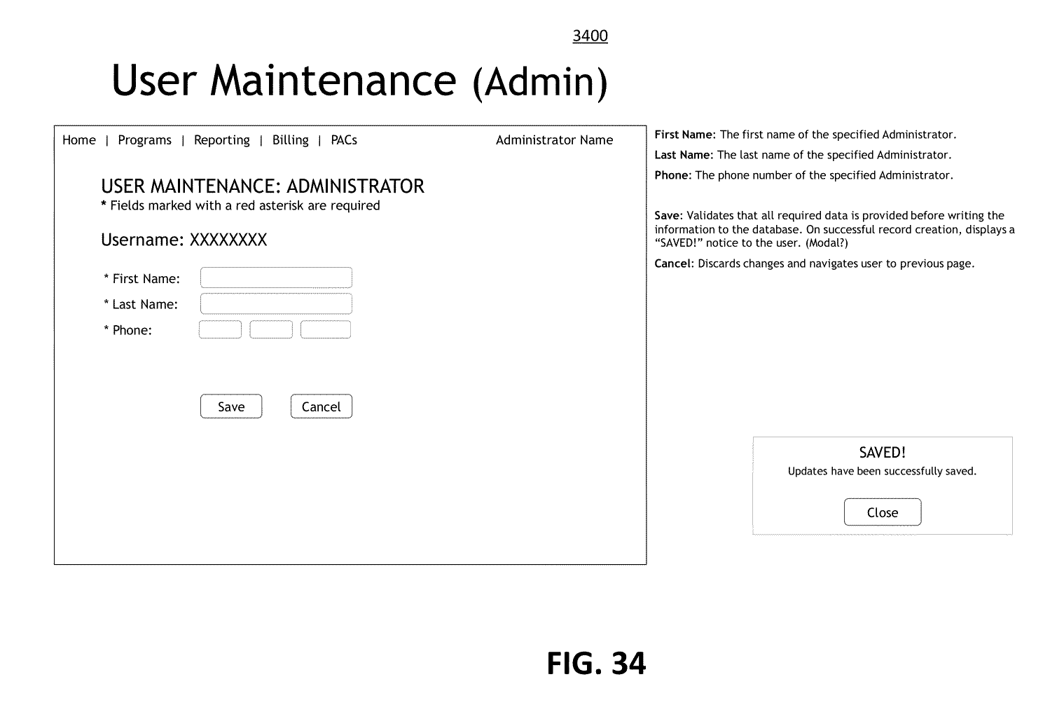

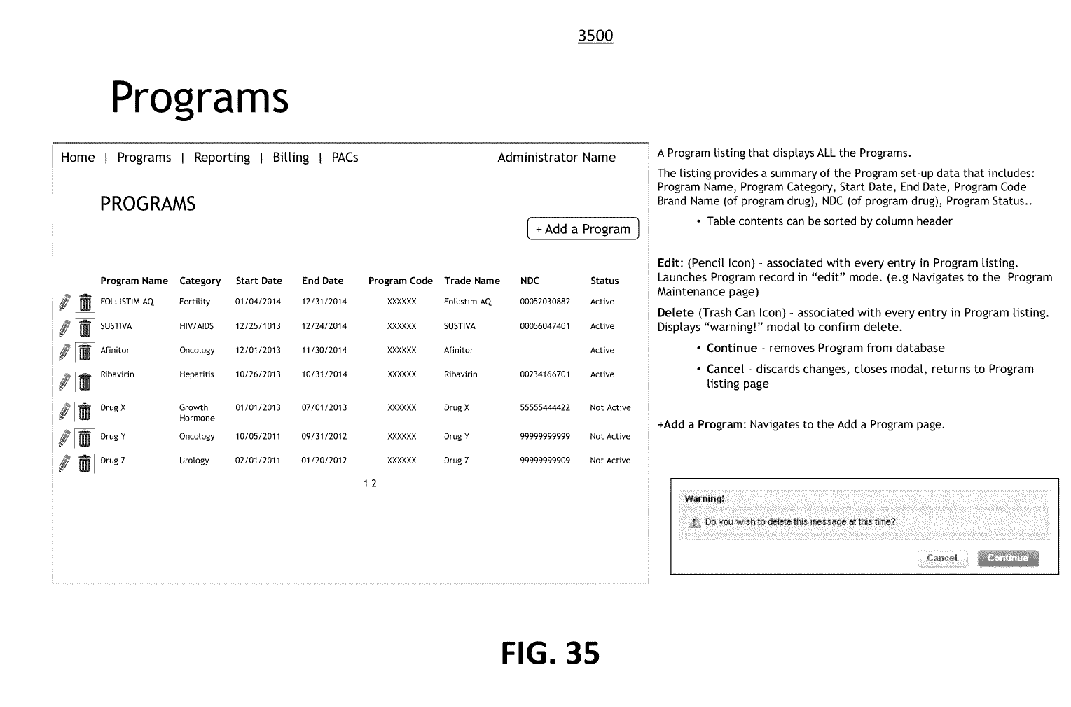

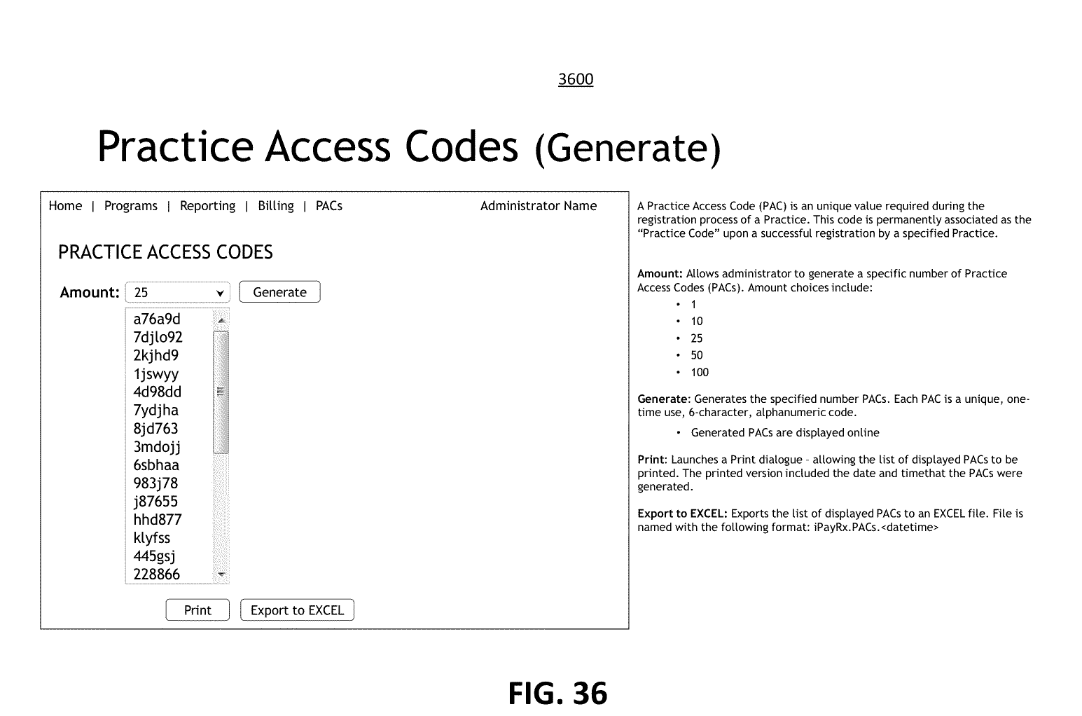

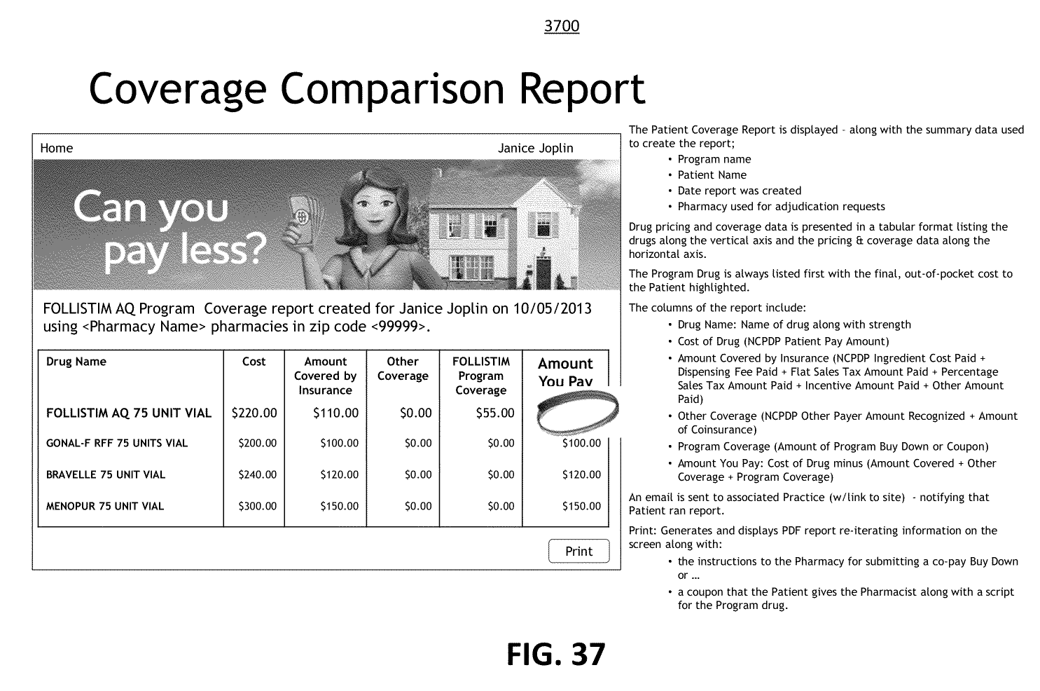

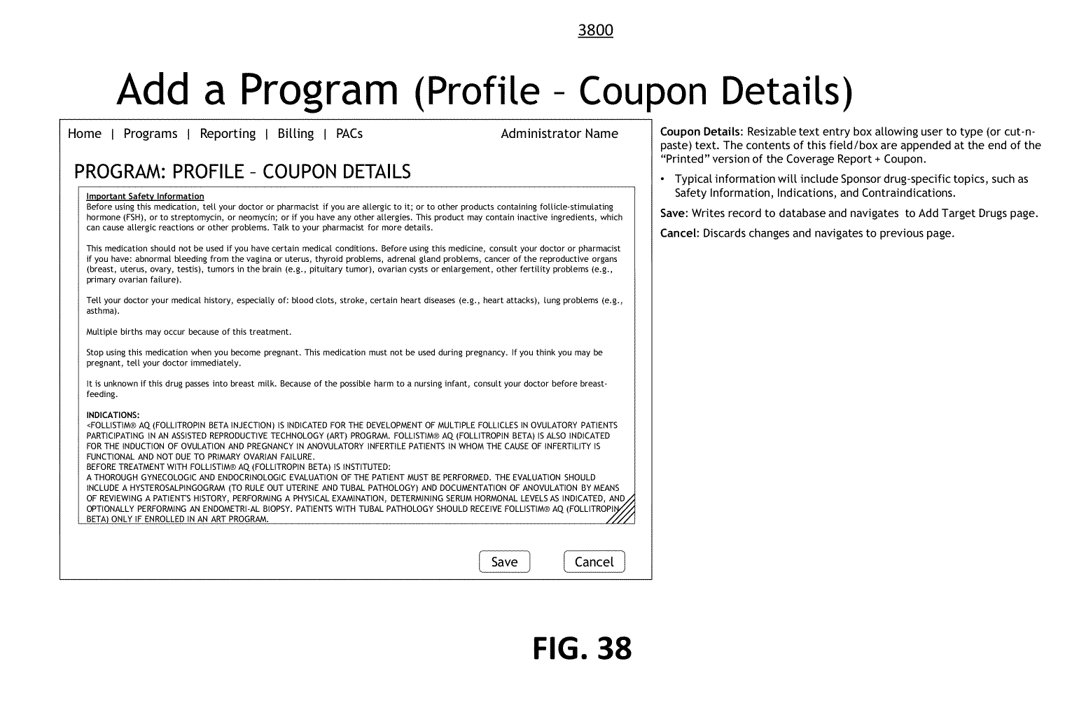

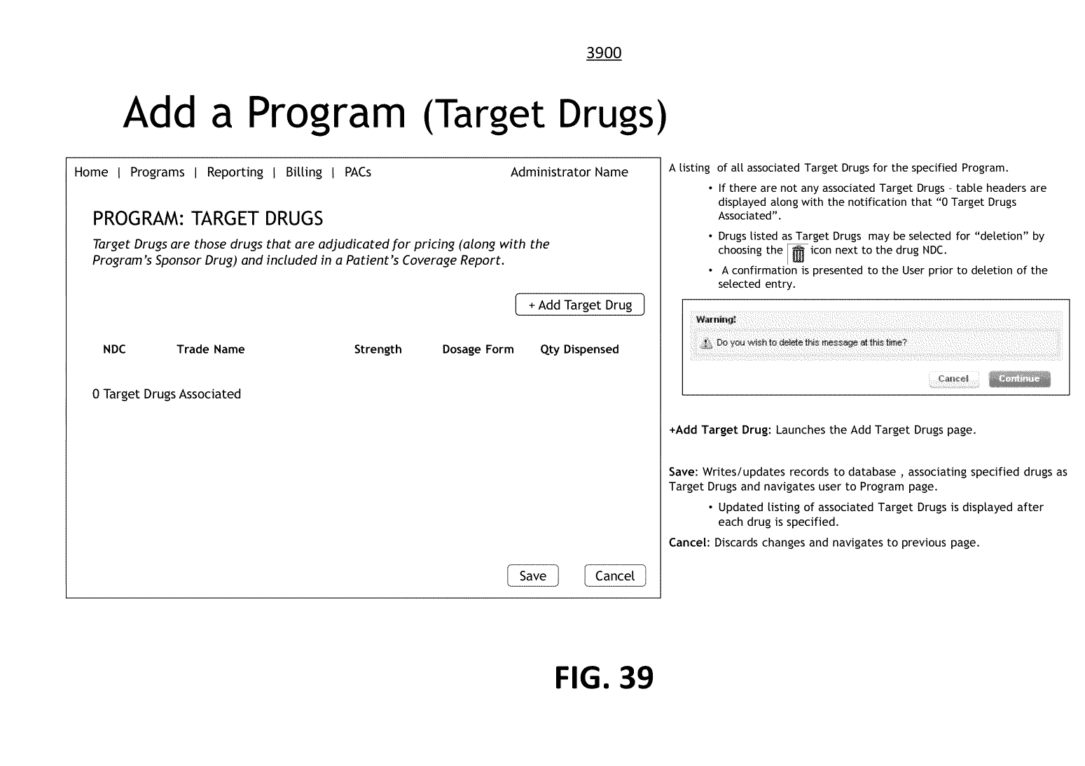

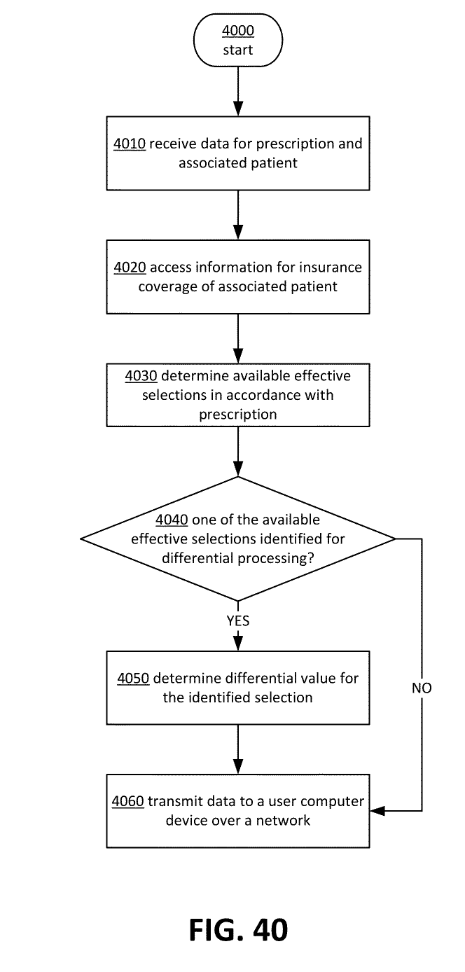

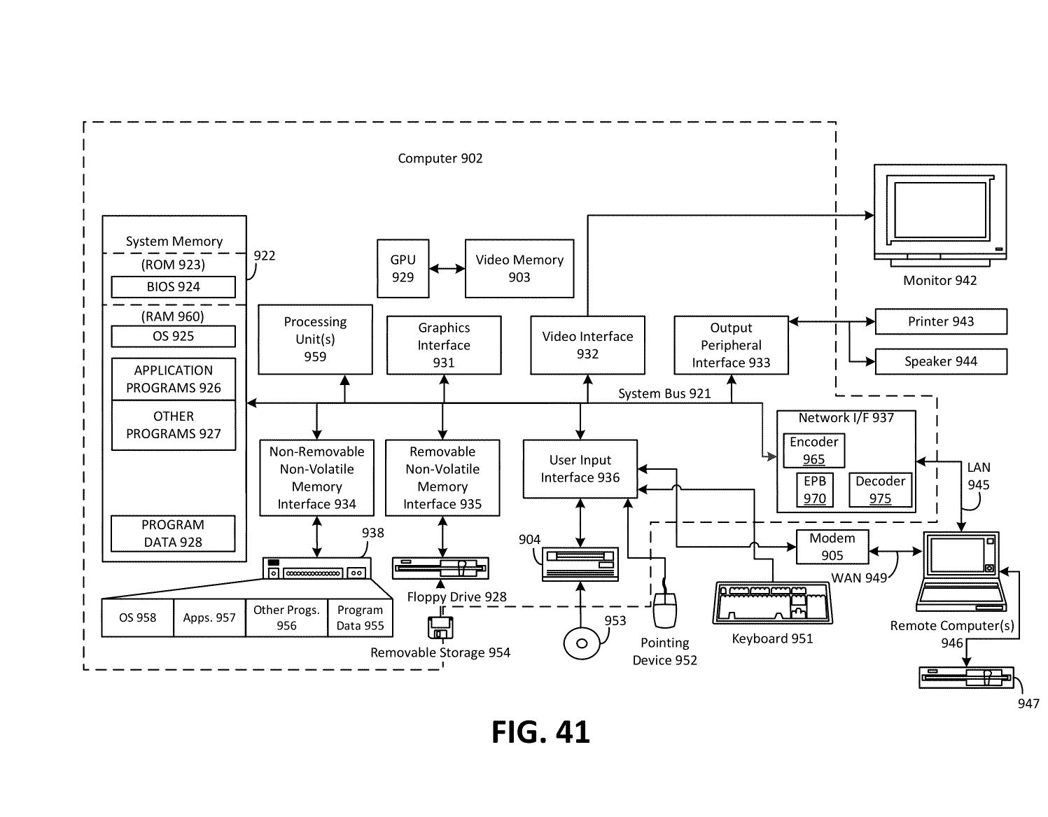

FIG. 19 illustrates a user interface 1900 and operations for providing medical information in accordance with the present disclosure. FIG. 19 illustrates information pertaining to an administration portal. Information may include, for example, patient insurance information maintenance.

FIG. 20 illustrates a user interface 2000 and operations for providing medical information in accordance with the present disclosure. FIG. 20 illustrates information pertaining to presentation of a differential value which, in one embodiment, is presented as a coupon. For example, a coupon associated with a specific coverage report may be displayed. Additional information may include the patient ID number, BIN#, Group#, and Coupon ID.

FIG. 21 illustrates a user interface 2100 and operations for providing medical information in accordance with the present disclosure. FIG. 21 illustrates information pertaining to an administration portal for pharmacy profile maintenance. Information may include, for example, users that match specified criteria, and pharmacy profile information.

FIG. 22 illustrates a user interface 2200 and operations for providing medical information in accordance with the present disclosure. FIG. 22 illustrates information pertaining to patient coverage report. Information may include, for example, program name, patient name, and pharmacy used for adjudication requests.

FIG. 23 illustrates a user interface 2300 and operations for providing medical information in accordance with the present disclosure. FIG. 23 illustrates information pertaining to presentation of a differential value which, in one embodiment, is presented as a coupon. For example, a coupon associated with a specific coverage report may be displayed.

FIG. 24 illustrates a user interface 2400 and operations for providing medical information in accordance with the present disclosure. FIG. 24 illustrates information pertaining to presentation of a patient coverage report. Information may include, for example, selection of a program to be included in the coverage report. Information may also include patient search criteria (e.g. first name, last name, and date of birth) for execution of a search of patients within the active practice session. Information may further include a zip code to execute the search of pharmacy locations within the zip code, and a search radius for display of pharmacies located within the specified travel radius.

FIG. 25 illustrates a user interface 2500 and operations for providing medical information in accordance with the present disclosure. FIG. 25 illustrates information pertaining to presentation of a patient activity report. Information may include, for example, program name, name of patient, date invited, date enrolled, and a hyperlink that launches a usage report for the patient and program combination specified on the activity report record.

FIG. 26 illustrates a user interface 2600 and operations for providing medical information in accordance with the present disclosure. FIG. 26 illustrates information pertaining to presentation of a patient usage report. Information may, for example, allow a practice to review a patient's medication claims activity for a period of time for specified program(s). Information may include the first date included in reporting period, the last date included in reporting period, selection of programs associated to the practice that are to be included in the report, the selection of patients associated to the practice, the brand name of drug associated to the transaction, the supply dispensed on the specified fill, the date that the RX was filled, the name of the prescriber associated to the RX, the name of the pharmacy that dispensed the medication.

FIG. 27 illustrates a user interface 2700 and operations for providing medical information in accordance with the present disclosure. FIG. 27 illustrates information pertaining to presentation of practice messages. Information may include, for example, a listing of system generated messages sent to the practice.

FIG. 28 illustrates a user interface 2800 and operations for providing medical information in accordance with the present disclosure. FIG. 28 illustrates information pertaining to presentation of practice messages. Information may include, for example, details for system generated messages sent to the practice.

FIG. 29 illustrates operations 2900 for providing medical information in accordance with the present disclosure. FIG. 29 illustrates information pertaining to practice code and program code logic. In some embodiments, the practice registration code may cause the portal to generate a list of unique, 6 character, alphanumeric practice registration codes (PRCs) that the manufacturer representatives may use to provide to practices, enabling the practice to register online for the programs described herein. The PRC may be implemented as a single use code that may be associated to the specific practice after a successful registration. The practice code may be unique to a practice. Once the practice registers with the access code, a unique practice code may be generated and assigned to the specified practice. The program code may be unique to a program. The program code may be implemented as a unique, numeric code that may be assigned to each program set-up at the website. The patient registration code may be a combination of practice code and program code, along with a “W” alpha connecter character in-between the codes to make up the patient registration code for that specified practice and program. In one example, a universal access code may be 56487 and provided to the practice by the manufacturer's representative. The practice may register with universal access code 56487 and may be assigned 2112 as a practice code. Program “X” may be set up with code 51. The “2112” practice may give a patient registration code of “2112W51” to patients to use for individual registration specifically for program “X.”

FIG. 30 illustrates operations 3000 for providing medical information in accordance with the present disclosure. FIG. 30 illustrates information pertaining to calculation of a differential value, which may be implemented in this example as a coupon value. In some embodiments, a coupon may be generated to bring the price of a drug to a selected value. The system may be configured to account for different manufacturers who may select different buy down amounts. In some embodiments, a maximum value may be set. The coupon may be set according to a sliding scale. For example, if one plan is selected for a buy down of $40, and another plan selects $60, the system may be configured to accommodate both selections on the fly.

FIG. 31 illustrates a user interface 3100 and operations for providing medical information in accordance with the present disclosure. FIG. 31 illustrates information pertaining to presentation of a coverage report. Information may include, for example, amounts covered by insurance, and amounts covered based on a generated coupon.

FIG. 32 illustrates a user interface 3200 and operations for providing medical information in accordance with the present disclosure. FIG. 32 illustrates information pertaining to user profile maintenance for finding a user.

FIG. 33 illustrates a user interface 3300 and operations for providing medical information in accordance with the present disclosure. FIG. 33 illustrates information pertaining to user profile maintenance for selecting a user.

FIG. 34 illustrates a user interface 3400 and operations for providing medical information in accordance with the present disclosure. FIG. 34 illustrates information pertaining to user maintenance for an administrator.

FIG. 35 illustrates a user interface 3500 and operations for providing medical information in accordance with the present disclosure. FIG. 35 illustrates information pertaining to presentation of programs. Information may include, for example, a program listing that displays programs including a summary of the program set-up data such as program name, program category, start date, end date, program code brand name of program drug, NDC of program drug, and program status.

FIG. 36 illustrates a user interface 3600 and operations for providing medical information in accordance with the present disclosure. FIG. 36 illustrates information pertaining to generation of practice access codes. A practice access code (PAC) may be a unique value used during the registration process of a practice. In one embodiment, a PAC may be a unique, one-time use, 6-character, alphanumeric code.

FIG. 37 illustrates a user interface 3700 and operations for providing medical information in accordance with the present disclosure. FIG. 37 illustrates information pertaining to coverage comparison reports. In one embodiment, the patient coverage report may include, along with the summary data used to create the report, program name, patient name, date report was created, the pharmacy used for adjudication requests, and drug pricing and coverage data in a tabular format listing the drugs along the vertical axis and the pricing/coverage data along the horizontal axis. The information may also include the out-of-pocket cost to the patient, name of the drug along with strength, cost of the drug (NCPDP patient pay amount), amount covered by insurance (NCPDP ingredient cost paid+dispensing fee paid+flat sales tax amount paid+percentage sales tax amount paid+incentive amount paid+other amount paid), other coverage (NCPDP other payer amount recognized+amount of coinsurance), program coverage (amount of program buy down or coupon), and amount to be paid: cost of drug minus (amount covered+other coverage+program coverage). In some embodiments, an email or other notification may be sent to associated practice, with a link to the site, indicating that a patient ran the report.

FIG. 38 illustrates a user interface 3800 and operations for providing medical information in accordance with the present disclosure. FIG. 38 illustrates information pertaining to coupon details in a program profile. In one embodiment, program profile may be updated to include coupon details which may be implemented as a resizable text entry box, allowing a user to type or enter text that may include sponsor drug-specific topics, such as safety information, indications, and contraindications.

FIG. 39 illustrates a user interface 3900 and operations for providing medical information in accordance with the present disclosure. FIG. 39 illustrates information pertaining to adding target drugs for a program. In one embodiment, a listing of associated target drugs for the specified program may be provided.

FIG. 40 illustrates an example operational procedure for providing medical information in accordance with the present disclosure. In an embodiment, the operational procedure may be implemented in a system comprising one or more computing devices in communication with each other. The computing devices may have memories that have stored thereon computer-executable instructions that, when executed, cause the system to perform operations as described. In one embodiment, the system may comprise a computing device as depicted in FIG. 40. Referring to FIG. 40, operation 4000 begins the operational procedure. Operation 4000 may be followed by operation 4010. Operation 4010 illustrates receiving data indicative of a prescription and an associated patient. Operation 4010 may be followed by operation 4020. Operation 4020 illustrates accessing information pertaining to insurance coverage of the associated patient.

Operation 4020 may be followed by operation 4030. Operation 4030 illustrates determining a plurality of available effective selections in accordance with the prescription.

Operation 4030 may be followed by operation 4040. Operation 4040 illustrates determining that one of the available effective selections is identified for differential processing.

If it is determined that one of the available effective selections is identified for differential processing, then operation 4040 may be followed by operation 4050. Operation 4050 illustrates determining a differential value for the identified selection based on the insurance coverage, values of the available effective selections, value of the selection identified for differential processing, and a predetermined maximum value for the differential value. In some embodiments, the predetermined maximum value may be one of a maximum cost and a maximum percentage. If it is determined that one of the available effective selections is not identified for differential processing, then operation 4040 may be followed by operation 4060.

Operation 4050 may be followed by operation 4060. Operation 4060 illustrates transmitting, by the system, data indicative of the available effective selections, associated values, and the differential value to a user computer device over a network.

In some embodiments, the plurality of available effective selections may be determined by accessing a database of selections. Furthermore, the data indicative of a prescription and an associated patient may be received from a device associated with a medical practitioner. Additionally, the data indicative of the prescription and associated patient may include at least one of: insurance information, personal information, medical history, and a prescription.

In some embodiments, the differential value for the identified selection may be determined and transmitted to the user computer device. Data indicative of a selection of one of the available effective selections may be received by the user computer device over the network.

The system and method described above may be implemented on one or more computing devices or environments, as described below. FIG. 41 depicts an example general purpose computing environment in which in which some of the techniques described herein may be embodied. The computing system environment 902 is only one example of a suitable computing environment and is not intended to suggest any limitation as to the scope of use or functionality of the presently disclosed subject matter. Neither should the computing environment 902 be interpreted as having any dependency or requirement relating to any one or combination of components illustrated in the example operating environment 902. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 902, which may include any of a mobile device or smart phone, tablet, laptop, desktop computer, etc., typically includes a variety of computer-readable media. Computer-readable media can be any available media that can be accessed by computer 902 and includes both volatile and nonvolatile media, removable and non-removable media. The system memory 922 includes computer-readable storage media in the form of volatile and/or nonvolatile memory such as read only memory (ROM) 923 and random access memory (RAM) 160. A basic input/output system 924 (BIOS), containing the basic routines that help to transfer information between elements within computer 902, such as during start-up, is typically stored in ROM 923. RAM 960 typically contains data and/or program modules that are immediately accessible to and/or presently being operated on by processing unit 959. By way of example, and not limitation, FIG. 41 illustrates operating system 925, application programs 926, other program modules 927, and program data 928.

The computer 902 may also include other removable/non-removable, volatile/nonvolatile computer storage media. By way of example only, FIG. 41 illustrates a hard disk drive 938 that reads from or writes to non-removable, nonvolatile magnetic media, a magnetic disk drive 939 that reads from or writes to a removable, nonvolatile magnetic disk 954, and an optical disk drive 14 that reads from or writes to a removable, nonvolatile optical disk 953 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 938 is typically connected to the system bus 921 through an non-removable memory interface such as interface 934, and magnetic disk drive 939 and optical disk drive 904 are typically connected to the system bus 921 by a removable memory interface, such as interface 935.

The drives and their associated computer storage media discussed above and illustrated in FIG. 41, provide storage of computer-readable instructions, data structures, program modules and other data for the computer 902. In FIG. 41, for example, hard disk drive 938 is illustrated as storing operating system 958, application programs 957, other program modules 956, and program data 955. Note that these components can either be the same as or different from operating system 925, application programs 926, other program modules 927, and program data 928. Operating system 958, application programs 957, other program modules 956, and program data 955 are given different numbers here to illustrate that, at a minimum, they are different copies. A user may enter commands and information into the computer 902 through input devices such as a keyboard 951 and pointing device 952, commonly referred to as a mouse, trackball or touch pad. Other input devices (not shown) may include a microphone, joystick, game pad, satellite dish, scanner, or the like. These and other input devices are often connected to the processing unit 959 through a user input interface 936 that is coupled to the system bus, but may be connected by other interface and bus structures, such as a parallel port, game port or a universal serial bus (USB). A monitor 942 or other type of display device is also connected to the system bus 921 via an interface, such as a video interface 932. In addition to the monitor, computers may also include other peripheral output devices such as speakers 944 and printer 943, such as a 3D printer, which may be connected through a output peripheral interface 933.

The computer 902 may operate in a networked environment using logical connections to one or more remote computers, such as a remote computer 946. The remote computer 946 may be a personal computer, a server, a router, a network PC, a peer device or other common network node, and typically includes many or all of the elements described above relative to the computer 902, although only a memory storage device 947 has been illustrated in FIG. 41. The logical connections depicted in FIG. 9 include a local area network (LAN) 945 and a wide area network (WAN) 949, but may also include other networks. Such networking environments are commonplace in offices, enterprise-wide computer networks, intranets and the Internet.

When used in a LAN networking environment, the computer 902 is connected to the LAN 945 through a network interface or adapter 937. As illustrated, the network interface 937 may include an encoder 965, a decoder 975, and an EPB component 970, which may implement the techniques described above for selective insertion of EPBs into unencrypted data for transmission. Encoder 965, decoder 975, and EPB component 970, may additionally or alternatively be implemented by or in conjunction with processing unit(s) 959 or other components of computing device 902, such as to enable conversion between data formats for storage or other purposes. When used in a WAN networking environment, the computer 902 typically includes a modem 905 or other means for establishing communications over the WAN 949, such as the Internet. The modem 905, which may be internal or external, may be connected to the system bus 921 via the user input interface 936, or other appropriate mechanism. In a networked environment, program modules depicted relative to the computer 902, or portions thereof, may be stored in the remote memory storage device. By way of example, and not limitation, FIG. 41 illustrates remote application programs 948 as residing on memory device 947. It will be appreciated that the network connections shown are example and other means of establishing a communications link between the computers may be used.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed:

1. A system for providing medical information, the system comprising:
one or more computing devices; and
one or more memories having stored thereon computer-executable instructions that, upon execution, cause the system to perform operations comprising:
receiving data indicative of a prescription and an associated patient;
accessing information pertaining to insurance coverage of the associated patient;
determining a plurality of available effective selections in accordance with the prescription;
determining that one of the available effective selections is identified for differential processing;
determining a differential value for the identified selection based on the insurance coverage, values of the available effective selections, value of the selection identified for differential processing, and a predetermined maximum value for the differential value; and
transmitting, by the system, data indicative of the available effective selections, associated values, and the differential value to a user computer device over a network.

2. The system of claim 1, wherein the plurality of available effective selections is determined by accessing a database of selections.

3. The system of claim 1, wherein the data indicative of a prescription and an associated patient is received from a device associated with a medical practitioner.

4. The system of claim 1, wherein the data indicative of the prescription and associated patient includes at least one of: insurance information, personal information, medical history, and a prescription.

5. The system of claim 1, wherein the differential value for the identified selection is determined and transmitted to the user computer device.

6. The system in claim 1, further comprising receiving, from the user computer device over the network, data indicative of a selection of one of the available effective selections.

7. The system in claim 1, wherein the predetermined maximum value is one of a maximum cost and a maximum percentage.

8. A method for providing medical information, the method comprising:
receiving, by a computing system, data indicative of a prescription and an associated patient;
accessing, by the computing system, information pertaining to insurance coverage of the associated patient;
determining, by the computing system, a plurality of available effective selections in accordance with the prescription;
determining, by the computing system, that one of the available effective selections is identified for differential processing;
determining, by the computing system, a differential value for the identified selection based on the insurance coverage, values of the available effective selections, value of the selection identified for differential processing, and a predetermined maximum value for the differential value; and
transmitting, by the computing system, data indicative of the available effective selections, associated values, and the differential value to a user computer device over a network.

9. The method of claim 8, wherein the plurality of available effective selections is determined by accessing a database of selections.

10. The method of claim 8, wherein the data indicative of a prescription and an associated patient is received from a device associated with a medical practitioner.

11. The method of claim 8, wherein the data indicative of the prescription and associated patient includes at least one of: insurance information, personal information, medical history, and a prescription.

12. The method of claim 8, wherein the differential value for the identified selection is determined and transmitted to the user computer device.

13. The method in claim 8, further comprising receiving, from the user computer device over the network, data indicative of a selection of one of the available effective selections.

14. The method in claim 8, wherein the predetermined maximum value is one of a maximum cost and a maximum percentage.

15. A computer readable storage medium having stored thereon instructions that, upon execution by one or more computing devices, cause the one or more computing devices at least to:
receive data indicative of a prescription and an associated patient;
access information pertaining to insurance coverage of the associated patient;
determine a plurality of available effective selections in accordance with the prescription;
determine that one of the available effective selections is identified for differential processing;
determine a differential value for the identified selection based on the insurance coverage, values of the available effective selections, value of the selection identified for differential processing, and a predetermined maximum value for the differential value; and
transmit data indicative of the available effective selections, associated values, and the differential value to a user computer device over a network.

16. The computer readable storage medium of claim 15, wherein the data indicative of a prescription and an associated patient is received from a device associated with a medical practitioner.

17. The computer readable storage medium of claim 15, wherein the data indicative of the prescription and associated patient includes at least one of: insurance information, personal information, medical history, and a prescription.

18. The computer readable storage medium of claim 15, wherein the differential value for the identified selection is determined and transmitted to the user computer device.

19. The computer readable storage medium in claim 15, further comprising receiving, from the user computer device over the network, data indicative of a selection of one of the available effective selections.

20. The computer readable storage medium in claim 15, wherein the predetermined maximum value is one of a maximum cost and a maximum percentage.
